(19) United States
(12) Patent Application Publication
(10) Pub. No.: US 2026/0050942 A1
(43) Pub. Date: Feb. 19, 2026

(54) INTEROPERABILITY OF ACCOUNTS AND DATA ACROSS DISTINCT COMPUTING PLATFORMS

(71) Applicant: Stephen Paulos, San Francisco, CA (US)

(72) Inventor: Stephen Paulos, San Francisco, CA (US)

(73) Assignee: Wells Fargo Bank, N.A., San Francisco, CA (US)

(21) Appl. No.: 18/807,786

(22) Filed: Aug. 16, 2024

(51) Int. Cl. G06Q 30/0226

(52) U.S. Cl. CPC G06Q 30/0227

(57) ABSTRACT

Systems, computer-readable media, devices, and methods for synchronizing user data of a user. The method can include identifying a recognition unit corresponding to a first state of a plurality of states and to a linked merchant of a plurality of linked merchants or to a provider. The method can include generating actionable elements with content corresponding to the recognition unit, and the actionable elements can correspond with a state change from the first state to a second state based on a merchant-provider exchange parameter. The method can include providing the actionable elements to a GUI, receiving a selection corresponding with a request to update states, and updating the first state to the second state. Updating can including deducting the recognition unit from a first account, calculating an equivalent recognition unit value based on the merchant-provider exchange parameter, and allocating the recognition unit to a second account.

### TECHNICAL FIELD

The present disclosure relates to the field of providing interoperability between and among accounts of users across separate entities. More particularly, the aspects and embodiments of the present disclosure relate to linking or synchronizing multiple computing platforms to facilitate, for example, interoperability of accounts and data maintained by separate enterprise computing systems.

### BACKGROUND

In a networked environment such as the internet, users and entities such as individuals, providers, and merchants regularly transact and exchange data. A user can earn points based on transactions between the user and a merchant, and the points can be used with that merchant. The points may be issued by a service provider computing system of a service provider facilitating the transaction. However, the points are not redeemable with other entities including the service provider due to various technical barriers.

### SUMMARY

One embodiment relates to a method for synchronizing user data of a user. In some embodiments, the method can include identifying, by one or more processing circuits, recognition units of the user. In some embodiments, at least one recognition unit of multiple recognition units corresponds to a first state of multiple states. In some embodiments, the at least one recognition unit can correspond to at least one linked merchant of multiple linked merchants. In some embodiments, the at least one recognition unit can correspond to a provider. In some embodiments, the method includes generating, by the one or more processing circuits, one or more actionable elements including content corresponding to the at least one recognition unit. In some embodiments, at least one of the one or more actionable elements corresponds with a state change from the first state of the multiple states to a second state of the multiple states based on a merchant-provider exchange parameter. In some embodiments, the method includes providing, by the one or more processing circuits, the one or more actionable elements to a graphical user interface (GUI) of a provider mobile application on a mobile device of the user. In some embodiments, the method includes receiving, by the one or more processing circuits and via the GUI, a selection of the one or more actionable elements corresponding with a request to update a portion of the first state of the at least one recognition unit to the second state based on the merchant-provider exchange parameter. In some embodiments, the method includes updating, by the one or more processing circuits, the portion of the first state of the at least one recognition unit to the second state. In some embodiments, updating includes deducting, by the one or more processing circuits, the at least one recognition unit from a first account of the user. In some embodiments, updating includes calculating, by the one or more processing circuits, an equivalent recognition unit value based on the merchant-provider exchange parameter. In some embodiments, updating includes further updating, by the one or more processing circuits, a recognition unit value of the at least one recognition unit based on the equivalent recognition unit value. In some embodiments, updating includes allocating, by the one or more processing circuits, the at least one recognition unit to a second account of the user based on the equivalent recognition unit value and the second state of the multiple states.

Another embodiment relates to a system for synchronizing user data of a user. In some embodiments, the system includes one or more processing circuits configured to identify multiple recognition units of the user. In some embodiments, at least one recognition unit of the multiple recognition units corresponds to a first state of multiple states. In some embodiments, the at least one recognition unit corresponds to at least one linked merchant of multiple linked merchants or corresponds to a provider. In some embodiments, the one or more processing circuits can be configured to generate one or more actionable elements including content corresponding to the at least one recognition unit. In some embodiments, at least one of the one or more actionable elements corresponds with a state change from the first state of the multiple states to a second state of the multiple states based on a merchant-provider exchange parameter. In some embodiments, the one or more processing circuits can be configured to provide the one or more actionable elements to a graphical user interface (GUI) of a provider mobile application on a mobile device of the user. In some embodiments, the one or more processing circuits can be configured to receive, via the GUI, a selection of the one or more actionable elements corresponding with a request to update a portion of the first state of the at least one recognition unit to the second state based on the merchant-provider exchange parameter. In some embodiments, the one or more processing circuits can be configured to update the portion of the first state of the at least one recognition unit to the second state. In some embodiments, updating includes deducting the at least one recognition unit from a first account of the user. In some embodiments, updating includes calculating an equivalent recognition unit value based on the merchant-provider exchange parameter. In some embodiments, updating includes further updating a recognition unit value of the at least one recognition unit based on the equivalent recognition unit value. In some embodiments, updating includes allocating the at least one recognition unit to a second account of the user based on the equivalent recognition unit value and the second state of the multiple states.

Still another embodiment relates to a non-transitory computer readable medium (CRM) including one or more instructions stored thereon that, when executed by one or more processing circuits, cause the one or more processing circuits to perform operations including identifying multiple recognition units of the user. In some embodiments, at least one recognition unit of the multiple recognition units corresponds to a first state of multiple states. In some embodiments, the at least one recognition unit corresponds to at least one linked merchant of multiple linked merchants or corresponds to a provider. In some embodiments, the one or more processing circuits can be configured to generate one or more actionable elements including content corresponding to the at least one recognition unit. In some embodiments, at least one of the one or more actionable elements corresponds with a state change from the first state of the multiple states to a second state of the multiple states based on a merchant-provider exchange parameter. In some embodiments, the one or more processing circuits can be configured to provide the one or more actionable elements to a graphical user interface (GUI) of a provider mobile application on a mobile device of the user. In some embodiments, the one or more processing circuits can be configured to receive, via the GUI, a selection of the one or more actionable elements corresponding with a request to update a portion of the first state of the at least one recognition unit to the second state based on the merchant-provider exchange parameter. In some embodiments, the one or more processing circuits can be configured to update the portion of the first state of the at least one recognition unit to the second state. In some embodiments, updating includes deducting the at least one recognition unit from a first account of the user. In some embodiments, updating includes calculating an equivalent recognition unit value based on the merchant-provider exchange parameter. In some embodiment, updating includes further updating a recognition unit value of the at least one recognition unit based on the equivalent recognition unit value. In some embodiments, updating includes allocating the at least one recognition unit to a second account of the user based on the equivalent recognition unit value and the second state of the multiple states.

Numerous specific details are provided to impart a thorough understanding of embodiments of the subject matter of the present disclosure. The described features of the subject matter of the present disclosure can be combined in any suitable manner in one or more embodiments and/or implementations. In this regard, one or more features of an aspect of the embodiments can be combined with one or more features of a different aspect of the embodiments. Moreover, additional features can be recognized in certain embodiments and/or implementations that can not be present in all embodiments or implementations.

### BRIEF DESCRIPTION OF THE FIGURES

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 is a block diagram depicting an example of a computing environment with a provider exchange system, according to some arrangements;

FIG. 2 is a flowchart for a method for synchronizing or linking user data or recognition units, according to some arrangements;

FIG. 3 is a block diagram illustrating an example computing system suitable for use in the various arrangements described herein; and

FIGS. 4A-4B are example graphical user interfaces depicting an application user interface, according to some arrangements.

It will be recognized that some or all the Figures are schematic representations for purposes of illustration. The Figures are provided for the purpose of illustrating one or more embodiments with the explicit understanding that they will not be used to limit the scope or the meaning of the claims.

### DETAILED DESCRIPTION

Referring generally to the Figures, the systems, apparatuses, and methods disclosed herein relate to integrating data and facilitating system interoperability. In many systems, synchronizing and/or converting recognition units (e.g., rewards, points, loyalty units, and/or credits) for transactions or exchanges between different merchants and a provider can introduce technical inefficiencies and problems. Typically, points and rewards are confined to separate ecosystems, where merchant-specific rewards (e.g., retailer points) can only be redeemed within that particular merchant's environment. Current solutions offer limited integration, often facilitating only one-way conversion from service provider (e.g., a financial institution, “FI”) rewards to merchant rewards and primarily within selected or isolated industries or sectors (e.g., travel sector). Existing solutions, however, do not address the fundamental challenge of enabling cross-ecosystem interoperability, and users are restricted by the closed nature of merchant ecosystems, resulting in fragmented reward management and limited flexibility in utilizing accumulated rewards. This fragmentation poses technical challenges, as users are unable to convert their merchant rewards into more universally applicable provider statement credits or rewards, thereby reducing the overall utility and value of their accumulated points. Presently, there is no comprehensive solution to integrate various merchant and provider systems to allow for the conversion of merchant-specific rewards into provider statement credits or provider rewards. This gap exists due to various technical barriers, including the differing architectures of provider and merchant systems and the restrictive nature of merchant-specific rewards, which are not generally designed to be transferable or usable across different merchants or FIs. This lack of interoperability leads to significant user inconvenience, inability to redeem rewards, and/or the underutilization of accumulated rewards.

Further, in many systems, users navigate multiple interfaces to allocate or convert points or currency, view and select different conversion rates, verify transaction details, and access various services (e.g., loading separate applications, accessing multiple web portals, etc.). This process can be particularly burdensome when users attempt to convert merchant rewards into provider credits. Users can not know the most advantageous conversion rates or how to effectively track allocated reward credits, leading to less optimal conversions, missed notifications, and increased latency in transaction processing. Additionally, the computational demand from loading multiple applications and web interfaces on a single device for managing transaction data or reward credits can impose a significant resource load on devices with limited processing power and memory, such as mobile devices. This can result in degraded performance and increased battery consumption. These inefficiencies can degrade user experience by increasing the computational load and memory usage of the device, leading to slower performance (e.g., longer loading times) and quicker battery drain. Additionally, the fragmentation of transaction management and reward allocation across multiple platforms can lead to data integrity issues and inconsistent data states. Accordingly, there is a need for systems and methods that can facilitate transaction management, determine and apply the most favorable exchange rates for rewards and credits, and integrate this information into a single interface. The systems and methods described herein can enhance system interoperability, improve computational efficiency, reduce memory usage, and minimize resource load on devices while effectively managing the conversion of merchant rewards into provider credits.

The systems, computer-readable media, devices, and methods described herein can provide a synchronization architecture or two-way allocation environment that offers technical advantages by improving the synchronization and allocation of reward credits across multiple merchants and their conversion into provider credits (e.g., provider statement credits, reward points, loyalty units, bonus credits, and/or any other reward mechanisms) using a linked payment instrument. By consolidating the tasks of synchronizing and converting rewards into a single interface, users can efficiently allocate merchant reward credits as provider credits without the need to load and switch between multiple applications and web portals. This integration can improve the process of managing and redeeming rewards, particularly when converting points or credits from a merchant to a provider, or vice-versa. Consolidating these tasks or actions into a unified interface can decrease the overall processing power required and reduce redundant data storage and processing operations, leading to lower memory usage on various computing devices, such as mobile devices. This consolidation can minimize the strain on mobile device resources, leading to faster performance and extended battery life. Additionally, determining conversion rates and integrating rewards information into a unified interface can enhance data consistency and accuracy by reducing the likelihood of errors and discrepancies that can arise from fragmented rewards synchronization. The embodiments can provide a technically improved graphical user interface while technologically improving the computational efficiency and resource management of resource-limited devices (e.g., mobile phones).

The systems, computer-readable media, devices, and methods described herein can also provide technical improvements by enhancing data security and privacy in the allocation and conversion of reward credits from multiple merchants into provider credits, or other merchant credits. By utilizing a secure and/or centralized system for synchronizing rewards data, users can manage their reward credits without repeatedly entering sensitive login credentials across various platforms. This can minimize the exposure of sensitive data, such as usernames, passwords, and account details, thereby lowering the risk of interception and unauthorized access. Additionally, the systems, computer-readable media, devices, and methods described herein can regularly or continuously (e.g., real-time, near real-time, periodically, etc.) verify authorization statuses through secure data communications links to process sensitive information in a controlled and protected environment. The use of secure data communications links can also reduce the attack surface for potential cyber threats (e.g., malware, spyware, phishing, DDoS, etc.) and strengthen the overall security posture of the system, improving data security for the user, the provider, and the merchants. Moreover, the consolidation of rewards synchronization processes into a unified and secure interface can facilitate the implementation of various security measures, such as encryption and multi-factor authentication, to further safeguard or protect user data. Secure data communication links between the provider and different platform systems can be used to facilitate the exchange of sensitive information, such as transaction data and reward criteria, and the use of such links can further reduce the risk of data breaches. These technical improvements can provide more secure and resilient systems, computer-readable media, devices, and methods for synchronizing and converting rewards into service provider credits, protecting against data breaches and enhancing user privacy.

The systems, computer-readable media, devices, and methods described herein offer further technical benefits by improving the process of synchronization and real-time data processing. By centralizing the retrieval and analysis of data across multiple sources, the implementations can relatively accurately analyze and determine reward eligibility and calculate or determine reward amounts without manual intervention, which can reduce the processing time and computational resources required to facilitate reward programs or track rewards, particularly on mobile devices with limited capabilities. Further, the aspects and embodiments described herein can consolidate information into a unified interface so users can access data without navigating or launching multiple applications, thereby reducing memory usage on user devices. Additionally, the disclosed systems, computer-readable media, devices and methods may identify linked and unlinked data between the provider and third-party sources and further notify users of status updates (e.g., user reward status), thereby improving data transmission and integrity by assisting users in avoiding missed and/or unclaimed updates (e.g., rewards). The systems, computer-readable media, devices, and methods disclosed herein thus improve system interoperability, provide accurate information, and reduces the computational load on both the provider and user devices.

The systems, computer-readable media, devices, and methods described herein offer technical benefits by enhancing the functionality and efficiency of graphical user interfaces (GUIs) for data visualization and interactions. By integrating data visualization techniques, the implementations provide consolidated information from multiple sources in a user-friendly and intuitive manner. Further, the system facilitates access and understanding of user data and eligibility by providing users a unified software application to link multiple accounts (e.g., without the user navigating through multiple applications or websites to access such information). The systems and methods may further utilize dynamic UI components that update in real-time to reflect recent exchange data and reward calculations, thereby providing users with immediate or substantially immediate feedback. Additionally, the implementations may be configured for optimal performance and usability across various devices, including smartphones and tablets with limited processing power. Thus, the systems and methods disclosed herein further improve system interoperability, user interaction processes, and facilitating accurate access to information through GUIs. These and other features and benefits are described more fully herein below.

According to the present disclosure, systems, computer-readable media, devices, and methods are provided to facilitate the conversion of merchant currency, such as rewards points, into statement credits or other reward types at a customer's financial institution (FI) or provider. An example may be described as follows. A customer, Jane Doe, uses her financial institution's (FI's) or provider's mobile banking application (used herein interchangeably with “app”) to access her digital loyalty wallet, which includes linked accounts (e.g., reward accounts) with various merchants such as a coffee shop and an airline. A provider computing system can identify recognition units (e.g., rewards points) associated with Jane, and the recognition unit may correspond to a first state (e.g., unredeemed) and be linked with one or more of the various merchants. For example, the system can determine that Jane's coffee shop reward account has 100 unused merchant points initially (e.g., exclusively) redeemable with the coffee shop. The system can further generate actionable elements (e.g., user interface elements) corresponding to these recognition units, and one or more elements may indicate an update or a state change from the first state to a second state (e.g., redeemed for statement credit). The update to the allocation state may be based on a merchant-provider exchange parameter, such as a conversion rate, user's loyalty status with a particular merchant or provider, and so on. These actionable elements can be provided to a graphical user interface (GUI) of the mobile banking app, and a message can be presented to Jane stating: “You have earned merchant rewards that can be redeemed at your linked merchants. Choose a merchant to see the best redemption rates.” Jane can view a list of exchange rates and select the coffee shop (e.g., due to the coffee shop having a preferred or advantageous conversion rate), and the system can receive this selection via the GUI. Further, the system can update the portion of the first state of the recognition unit to the second state by deducting the recognition unit from Jane's merchant account (e.g., 100 points), calculate an equivalent recognition unit value based on the exchange parameter (e.g., 100 coffee shop points=$10 statement credit based on an exchange rate of 10 merchant points:1 provider point), and update the recognition unit value (e.g., to $10). The system can allocate the recognition unit to Jane's FI (or other provider) account based on the equivalent value and the second state and further update the GUI to indicate that Jane's rewards have been successfully redeemed by displaying the converted rewards points and the updated balance.

In another illustrative embodiment, the system facilitates users logging into a mobile or online banking platform to access a provider account (e.g., digital loyalty wallet, mobile banking platform, online banking app, etc.) where they can manage various linked merchant accounts and convert merchant rewards for redemption. For example, users can add or drop merchants via a selection page, which could include a drop-down menu of preapproved merchants or a searchable field to identify new merchants. If a merchant is not preapproved, the system may send an invitation to the merchant to join the loyalty program. Once a merchant is selected, the system can make an API call to transmit user information for verification (e.g., name, merchant account number). The provider platform then confirms the addition of the merchant and retrieves real-time rewards balance information corresponding to an account (e.g., rewards account) at that merchant. Users can observe and manage their linked merchant accounts, and the system can further convert merchant rewards into provider statement credits or other rewards.

In another embodiment, the system includes a set-up method of operation with API flows to integrate merchant accounts with the provider platform. The process begins when the user logs into the mobile or online banking platform of their financial institution (FI) or provider and opens a page or tab for merchant points conversion. Within this interface, users can select merchants to link to their provider account through a drop-down menu or searchable field. If the merchant is preapproved, the system adds the merchant to the user's provider account by making an API call to transmit user information (e.g., full name, merchant account number, address) for verification. If the merchant is not preapproved, the system may send an invitation to join the loyalty program. Upon successful verification, the provider platform receives confirmation and retrieves real-time rewards balance information from the merchant. Users can view their linked merchant accounts and rewards balances in real-time and manage their merchant accounts by adding or dropping merchants as desired. For example, the user may observe, via mobile banking, their account linked to their now-linked merchants such as a coffee shop and an airline.

In another embodiment, in response to setting up the loyalty wallet, the system can provide users with access to linked merchant accounts to view corresponding rewards balances in real-time or near real-time. The system can display a graphical user interface (GUI) displaying all of the user's linked merchant accounts and the associated rewards balances. API calls specific to each merchant may be used to obtain real-time balance information. These API calls can include merchant account numbers and customer names to enable the merchant to identify the account and provide the requested balance information. Users can then redeem their merchant rewards for provider statement credits, or other rewards, by selecting the desired amount of rewards points, and specifying the provider account for redemption (e.g., demand deposit account, credit account, loan product). The system can transmit an API call to a merchant computing system of the merchant indicating the user's request to use the specified points, and receive confirmation from the merchant. Once the conversion is confirmed, the system can apply the statement credit to the user's provider account (e.g., to reduce a payment obligation), updating the allocation state of the recognition units and providing a confirmation message on the GUI. For instance, the conversion rates may be distinct between each partner/merchant and the financial institution, and in at least one example, the merchant may transmit a control instruction to the financial institution to set or adjust (e.g., increase or decrease)the conversion rate. The conversion rates may also differ based on the redemption destination, such as having a better exchange rate for a loan statement credit compared to a credit statement.

In some embodiments, the system may further provide a user interface with options to automatically convert merchant points to provider rewards based on predefined conditions, like balance thresholds (e.g., when a merchant point balance exceeds a predefined threshold), expiration dates (e.g., converting points before they expire), and the optimal conversion rates. The provider system can analyze the user's merchant rewards balance to detect changes and suggest or automatically redeem rewards that have not been used for a predefined time period (e.g., stale points). The user interface may also facilitate sorting and filtering of linked merchant accounts by category (e.g., travel, dining, shopping), balance totals, or behavioral patterns (e.g., most frequently used merchants).

In some embodiments, the system supports both pull and push scenarios for merchant rewards conversion. In a pull scenario, a conversion request may be initiated (e.g., in response to user input) from the provider platform. In a push scenario, a conversion request may be initiated from the merchant system based on user identified rewards. That is, the merchant system may push those rewards from the merchant to the financial institution based on input from the user at the merchant system (e.g., input received via a merchant rewards account). The system can use a similar account linking and synchronization process in both scenarios. For example, the merchant can provide a widget on their site to access push functionality, allowing customers to push rewards points to the provider for conversion. Merchants may also use an open API provided by the provider to control aspects of the conversion process, such as the conversion rate or algorithm. The system may offer a subscription service for users, utilizing intelligence to identify favorable conversion rates and automatically implement or alert users to these opportunities. For example, the system may analyze the customer's liabilities (e.g., bills) based on transaction and/or account data at the provider (i.e., financial institution) and suggest merchant point redemptions to satisfy those liabilities or recommend converting to products with the best value for redemption (e.g., a loan product with a better conversion rate than a credit card statement).

In some embodiments, the conversion of the desired amount of points may be performed by the merchant or the provider or other provider using a merchant computing system or other third party computing device. Each merchant may have their own conversion rate (e.g., X points earned with the merchant correspond to Y points at the financial institution). The conversion rates may also be different for each redemption destination (e.g., a loan statement credit may have a more advantageous or higher exchange rate relative to a credit statement). For example, the system can operate on a pull model, and the customer conversion request can originate on the provider platform (e.g., mobile banking, online banking, in a branch). Merchants can code to the specifications that the provider sets for the API to participate in the rewards transfer process. A customer/user who is applying a combination of rewards may utilize multiple conversion algorithms, and a user interface may show a rewards transfer total as one single value of statement credit despite multiple rewards conversions, or as multiple values corresponding with the multiple conversions. If the system receives a success response from the merchant, the merchant system can complete the transaction. Points that are FI-related (e.g., provider statement credits) can be burned (e.g., deleted on a provider system), and each partner/merchant computing system can also burn points (e.g., deleting corresponding points on a merchant back-end system) to avoid “double-dipping” or duplicate points existing in multiple customer accounts. A mobile or user device can present a GUI to customers to view the conversion on a GUI executed on the user device within a certain period, such as day from the conversion date.

In some embodiments, the provider (e.g., financial institution) and/or merchant computing system may settle each rewards transfer from a merchant to the provider for statement credit. The provider computing system and/or merchant computing system can execute a settlement process at the end of day or over any other period of time. In some embodiments, the user device can further provide a graphical user interface having an order history. The GUI may depict a line item for this redemption, send or transmit a confirmation email regarding the redemption, and/or perform a settlement process related to the redemption (e.g., via an API call or via batch processing).

In some embodiments, the system may implement or facilitate various improvements, such as artificial intelligence and/or machine learning (e.g., AI/ML). The system may provide an option to automatically apply merchant points from merchants based on detecting various conditions, such as balance value (e.g., when a merchant point balance exceeds a predefined threshold, the system converts that point balance to provider rewards) or expiration date (e.g., certain merchants cause their points to expire upon non-usage and/or after a predefined amount of time). These conditions can prevent a customer/user “losing” their merchant points (e.g., at the expiration date) by periodically automatically converting their balances to provider (e.g., financial institution) rewards. The system may analyze when certain merchant/partner rewards are expiring and notify the user to redeem those to statement credit (or, in some instances, automatically redeem those to statement credit). The system can further detect “stale” or “stalest points” (e.g., rewards that have not been used for a predefined amount of time), and the system may suggest redeeming, or may automatically redeem, such rewards. The system may analyze the merchant rewards balance to detect changes and identify which balances are most “stale.” The system can also detect a merchant category (e.g., travel, dining, shopping, which may be a category used to group similar merchants and/or exchanges for points allocation or conversion) and/or a preferred/best conversion rate (e.g., the provider system may assess the conversion rates for linked merchants and automatically convert merchant rewards to provider rewards when the conversion rate(s) correspond to predefined favorable values).

In some embodiments, the system may suggest other merchant points redemptions in place of, or in addition to, the selected merchant point redemptions. For example, the system may provide a notification on the user's device like the following: “We see you are trying to use 100 hotel points, and you would have a better return with 100 retail points,” to inform customer/user which merchant rewards to redeem (e.g., which merchant redemptions are best for statement credit at a particular time). The provider system may perform a liabilities assessment by analyzing the customer's liabilities (e.g., bills) and suggesting merchant point redemptions as a condition to satisfy those liabilities. The provider system may also perform a product assessment and recommend converting to certain products because those products have the best value for redemption (e.g., a conversion rate for a loan product may be better than for a credit card statement).

In some embodiments, the system may provide user interface enhancements including providing options for grouping merchants by category, balance totals, alphabetically, etc. A filter may be used to sort among the linked merchant accounts. For example, a user may select an option on a provider interface to sort by ascending/descending balance totals. As another example, a user may use elements on a GUI of a provider mobile application to sort by behavioral plan using the system. The merchant that is most often used for conversion may be provided at or near the top of the interface, and the merchant least used may be provided at the bottom of the sorted list on the interface. The aforementioned method of operation example can be described as a pull scenario, and other embodiments can include similar steps and/or methods performed in the form of a push. Thus, the system could be applicable with push, pull, or both scenarios. For example, the user may interact with a user device, linking the user directly to the merchant to identify rewards they wish to redeem to the provider, and the provider system can initiate a push of those rewards from the merchant to the provider. A similar account linking/synchronization process as described above may be used in this scenario as well. In embodiments involving a “push,” the customer conversion can originate on the merchant platform.

A merchant perspective of operations is described below. An SDK or plug-in may be provided to merchant partners to push data to the provider. A widget may be provided on the merchant site to access push functionality. The merchant may display to a customer (within the merchant rewards account) that a conversion has occurred, such as “100 reward points transferred to provider for $10 statement credit” or “−100 reward points.” Via the open API, partners/merchants may control merchant aspects of the process, such as the conversion rate/algorithm. In other embodiments, the system may include a merchant/partner portal, which may be accessible by various merchants and configured to control various conversions or related parameters (e.g., facilitating merchants alerting conversion rates with or without provider involvement).

As used herein, an “exchange” refers to a transaction or interaction involving the transfer of value between two or more parties. For example, exchanges can include, but are not limited to, financial transactions such as payments, refunds, etc. The exchanges may be effectuated via a mobile application, a credit card, etc. and occur at various locations, such as at a merchant's point of sale (e.g., credit card transactions, mobile wallet payments, etc.). As described herein, an “exchange” can refer to the accrual and/or redemption of recognition points, loyalty points, rewards, and/or membership benefits (e.g., points earned from a purchase, membership tier upgrades, etc.). Generally, performing or facilitating an exchange can include an initiation of the transaction (e.g., by the user from spending at various places, by a merchant in response to a user achieving a predefined points balance, etc.), a validation and/or authorization of the transaction by the provider and/or merchant, and an update of account information to reflect the completed transaction (e.g., a modification of a user's account or other data based on redeeming or converting rewards). In another example, an “exchange” can include, but is not limited to, a crediting or allocation of a sum or quantity of exchange rewards (e.g., 20 points) to a user (e.g., to a user's merchant account), a conversion of rewards or benefits of a first type to rewards or benefits of a second type (e.g., from rewards redeemable with a first merchant to a rewards redeemable with a second merchant), and so on.

It should be understood that while the present disclosure is explained mainly in regard to providing and managing the conversion of merchant rewards into financial institution statement credits or rewards, such a description is not meant to be limiting. The principles described herein may be applicable to various other types of data management systems and synchronization methods across different industries and applications. All such variations are intended to fall within the scope of the present disclosure.

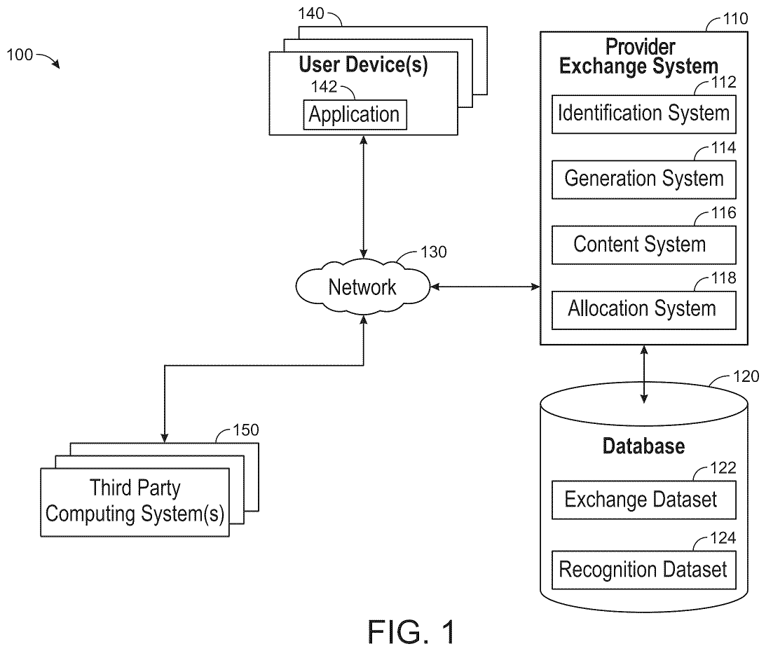

Referring now to FIG. 1, a block diagram depicting an example of a computing environment 100 with a provider exchange system 110 (collectively referred to herein as the “synchronization architecture” or “provider institution exchange system”) is shown, according to some arrangements. As shown, the environment 100 includes the provider exchange system 110, a database 120, a network 130, one or more user device(s) 140, and one or more third party computing system(s) 150. The provider exchange system 110 can include an identification system 112, a generation system 114, a content system 116, and an allocation system 118. The provider exchange system 110 can be communicatively coupled or linked to the database 120, and the database 120 can include an exchange dataset 122 (referred to as an exchange/account dataset) and a recognition dataset 124. The user device(s) 140 can include an application 142. Although the various computing elements of FIG. 1 can be described in the singular form below (e.g., network 130, user device 140, etc.), it should be understood that the computing environment 100 can include two or more of any device/system described herein (e.g., two or more network(s) 130, two or more user device(s) 140, etc.).

In various arrangements, components of the environment 100 communicate over network 130. Network 130 can include computer networks such as the Internet, local, wide, metro or other area networks, intranets, satellite networks, other computer networks such as voice or data mobile phone communication networks, combinations thereof, or any other type of electronic communications network. Network 130 can include or constitute a display network. In various implementations, network 130 facilitates secure communication between components of system 100. As a non-limiting example, network 130 can implement transport layer security (TLS), secure sockets layer (SSL), hypertext transfer protocol secure (HTTPS), and/or any other secure communication protocol.

In some arrangements, network 130 can be composed of various network devices (nodes) communicatively linked to form one or more data communication paths between participating devices. The network 130 can facilitate communication between the various nodes, such as the provider exchange system 110, database 120, one or more user device(s) 140, and one or more third party computing system(s) 150 (e.g., using an OSI layer-4 transport protocol such as the User Datagram Protocol (UDP), the Transmission Control Protocol (TCP), Stream Control Transmission Protocol (SCTP), etc.). Each networked device can include at least one network interface for receiving and/or transmitting data, typically as one or more data packets. An illustrative network 130 is the Internet (however, other networks can be used). Network 130 can be an autonomous system (AS), i.e., a network that is operated under a consistent unified routing policy (or at least appears to from outside the AS network) and is generally managed by a single administrative entity (e.g., a system operator, administrator, or administrative group). The provider exchange system 110 can be a computing system including at least one processor and memory, such as a computing device having at least one processing circuit configured to execute instructions stored in a memory device to perform one or more operations described herein. The provider exchange system 110 may be owned by, or otherwise associated with, a provider (e.g., provider institution). For example, the provider institution may be a financial institution, such as commercial or private banks, credit unions, investment brokerages, and so on. The provider institution may also include any commercial entity capable of maintaining charge accounts, including retailers, vendors, service providers, and the like. In some embodiment, the provider exchange system 110 may also include a card issuer and a card issuer computing system. The provider exchange system 110 may also be configured to manage charge accounts and authorize transactions involving debits from charge accounts associated with customers. In one example, the provider exchange system 110 can identify user accounts with third parties and analyze transactions (e.g., exchanges) with these third parties to identify accumulated credits and/or rewards opportunities. That is, the provider exchange system 110 can automatically perform account-related tasks for the provider, such as monitoring exchange histories, determining eligible transactions, and linking various third-party user accounts, as further described herein.

In the example shown, the provider exchange system 110 includes a plurality of sub-processing systems, shown as the identification system 112, generation system 114, content system 116, and allocation system 118 for synchronizing and linking recognition units between a various accounts of a provider, a user, and one or more third parties/merchants (e.g., for synchronizing merchant credits with a customer's provider account balance). In some arrangements, the provider exchange system 110 and/or included systems (e.g., identification system 112, generation system 114, etc.) can include at least one processing system or device, such as a computing device having at least one processing circuit configured to execute instructions stored in a memory device to perform one or more operations described herein. The processing circuit can include a processor, such as a microprocessor, an application specific integrated circuit (ASIC), a field-programmable gate array (FPGA), etc., or combinations thereof. The processing circuit can include a memory, and the memory can include, but is not limited to, electronic, optical, magnetic, or any other storage or transmission device capable of providing processor(s) with program instructions. The instructions can include code from any suitable computer programming language such as, but not limited to, ActionScript®, C, C++, C#, HTML, Java®, JavaScript®, Perl®, Python®, Visual Basic®, and XML.

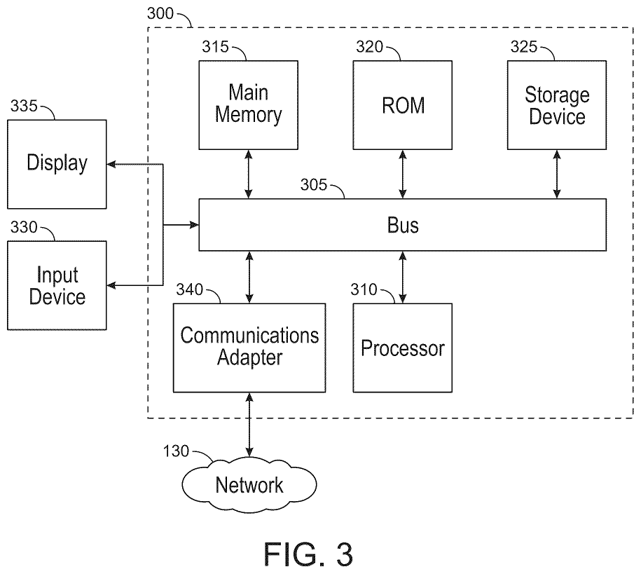

In some arrangements, the provider exchange system 110, database 120, user device(s) 140, and/or third party computing system(s) 150 can include the computing device depicted in FIG. 3 and described below, which can be used to run or otherwise implement the various functionalities and/or features described herein, such as converting merchant rewards to provider statement credits. In other arrangements, the provider exchange system 110 can be a server, distributed processing cluster, cloud processing system, or any other computing device or system. The provider exchange system 110 can include or execute at least one computer program or at least one script. In some implementations, the provider exchange system 110 includes combinations of software and hardware, such as one or more processors configured to execute one or more scripts. For example, the provider exchange system 110 can include one or more processing circuits (e.g., a processing circuit) including a processor and memory, and the memory can have instructions stored thereon that, when executed by the processor, cause the processing circuit to perform the various operations described herein. The operations described herein can be implemented using software, hardware, or a combination thereof. As mentioned above and herein, the processor(s) included in the processing circuit(s) of the provider exchange system 110 can include a microprocessor, ASIC, FPGA, etc., or combinations thereof, or can include a multi-core processor or an array of processors. The memory included in the processing circuit of the provider exchange system 110 can include, but is not limited to, electronic, optical, magnetic, or any other storage devices capable of providing a processor or processing circuit with program instructions. For example, the memory can include a floppy disk, CD-ROM, DVD, magnetic disk, memory chip, ROM, RAM, EEPROM, EPROM, flash memory, optical media, or any other suitable memory from which processor(s) can read instructions (e.g., one or more non-transitory CRM, one or more non-transitory computer-readable media (CRM) having instructions stored thereon that, when executed by one or more processing circuits, cause the one or more processing circuits to perform various functions, etc.).

In some arrangements, the provider exchange system 110 can include and/or be communicatively coupled to one or more databases (e.g., database 120). The databases may be structured as a data repository that is configured to store data, such as exchange history data or account data. For example, the database 120 can include data structures for storing information such as, but not limited to, exchange data and/or exchange information (e.g., exchange amount or transaction amount, exchange date or transaction date, exchange rewards data, merchant exchange data, etc.), account data and/or account information (e.g., linked accounts, unlinked accounts, existing/new accounts with providers/merchants, lists of accounts, account credentials including merchant usernames and merchant passcodes, etc.), recognition unit data or rewards data/information (e.g., eligible exchanges or transactions, merchant parameters such as exchange rewards rate, exchange rewards totals, calculated rewards, etc.), and/or other data or information. The database 120 can be part of the provider exchange system 110, or a separate component that the provider exchange system 110 or the user device 140 can access via the network 130. The database 120 can also be distributed throughout environment 100. For example, the database 120 can include multiple databases associated with the provider exchange system 110, a client device (E.g., user device 140), or both. In an example, the database 120 can include one or more storage mediums. The storage mediums can include, but are not limited to, magnetic storage, optical storage, flash storage, and/or RAM. In some arrangements, the provider exchange system 110 can implement or facilitate various APIs to perform database functions (i.e., managing, synchronizing, or linking data stored in database 120). The APIs can be but are not limited to SQL, ODBC, JDBC, NOSQL and/or any other data storage and manipulation API.

In some arrangements, the database 120 can include an exchange/account dataset 122 and a recognition dataset 124. The provider exchange system 110 can communicate with the database 120 (e.g., locally or via the network 130, etc.) to update stored information included in the exchange/account dataset 122 or the recognition dataset 124. Each of the database 120, exchange/account dataset 122, and/or recognition dataset 124 can include various information related to one or more users, merchants (e.g., vendors), providers (e.g., entities facilitating transactions/exchanges between users and merchants), exchanges (e.g., purchases between a user and a merchant or between a user and a provider), etc. In one example, the exchange/account dataset 122 can include data/information, referred to as exchange history data that provides an indication of a list of exchanges (e.g., transactions), exchange information (e.g., transaction or exchange date, merchant, exchange amount, etc.), and various additional data related to exchanges between one or more of a provider, merchant, and user. In some arrangements, the exchange/account dataset 122 can include account information (e.g. account history data, lists of linked or unlinked accounts, etc.). The account information can refer to (i) financial accounts of a user with a financial institution/provider (also referred to as provider accounts, user accounts with a provider, etc.), including but not limited to checking accounts, savings accounts, money market accounts, demand deposit accounts, certificates of deposit (CDs), individual retirement accounts (IRAs), brokerage accounts, credit card accounts, mortgage accounts, personal loan accounts, home equity lines of credit (HELOCs), and educational savings accounts (e.g., 529 plans); (ii) third-party accounts of a user with a third-party merchant/vendor (e.g., merchant accounts, user accounts with a merchant, etc.), including but not limited to merchant rewards accounts, loyalty accounts, recognition programs, membership benefits programs, store credit accounts, gift card balances, online marketplace accounts, subscription box service accounts, rental service accounts (e.g., car rentals, equipment rentals), and travel and hospitality accounts (e.g., airline frequent flyer programs, hotel loyalty programs, vacation rental accounts); (iii) third-party accounts of a user with other third-party entities, including but not limited to utility accounts (e.g., electricity, gas, water, internet), subscription services (e.g., streaming services, news subscriptions, software subscriptions), social media accounts, healthcare accounts (e.g., patient portals, medical billing accounts), and insurance accounts (e.g., policyholder accounts, claim tracking accounts); and/or (iv) various additional or alternative accounts involving one or more of the user, providers/financial institutions, merchants, or other entities, including but not limited to joint accounts, business accounts, investment accounts (e.g., brokerage accounts, mutual funds, pension plans), cryptocurrency wallets, crowdfunding accounts, charitable donation accounts, and government benefit accounts (e.g., social security accounts, unemployment benefits). For example, the exchange/account dataset 122 can include a list of a plurality of linked merchants (e.g., linked or authenticated user accounts with merchants given provider access), and the provider exchange system 110 can interface with the exchange/account dataset 122 (e.g., by accessing stored data, modifying data, etc.) to determine or update various merchant related information (e.g., merchant name, identifier, merchant-provider exchange rates/parameters, etc.).

In some arrangements, the recognition dataset 124 can include similar features and/or functionality as described regarding the exchange/account dataset 122, but can include recognition unit data or information (e.g. one or more recognition units, stored data corresponding to the recognition units, rewards criteria, merchant-provider exchange parameters, etc.). For example, the provider exchange system 110 can query the recognition dataset 124 in response to receiving a request to redeem one or more recognition units (e.g., a request to update at least a portion of a first state of one or more recognition units into a second state). For example, the recognition dataset 124 can include state information or state data corresponding to various recognition units and/or portions of states of the various recognition units (e.g., corresponding with whether recognition unit(s) are redeemable, unallocated, allocated, etc.), and the provider exchange system 110 can interface with the recognition dataset 124 (e.g., by accessing stored data, modifying data, etc.) to determine or update a portion of the state information, merchant/provider/exchange-related information (e.g., merchant name, identifier, exchange rates/parameters, recognition unit data such an allocation states, etc.) and other data associated with recognition unit redemption (e.g., list of eligible partner entities, conversion standards, etc.). For example, state information or state data can include a first state (e.g., merchant redemption state), a second state (e.g., provider redemption state), a third state (e.g., eligibility state, allocation state, etc.), and so on. The recognition dataset 124 can be linked with other computer devices through network 130 and can store recognition units (or data corresponding to recognition units) such that a provider mobile application can be used to access and further redeem or allocate the recognition units (e.g., from an allocation from a merchant account to a provider account, from a redemption of credits earned with a provider to merchant credits, etc.).

In some arrangements, the user device 140 (sometimes, depending on the configuration of the user device, the user device may be referred to herein as an “electronic device,” “mobile device,” or “mobile electronic device”) can be a computing device, personal computer (PC), desktop computer, laptop computer, smartphone, tablet, smart watch, smart sensor, or any other device configured to facilitate receiving, displaying, and interacting with content (e.g., applications, etc.) or data (e.g., recognition unit data, exchange parameters, allocation state updates or modifications, eligibility determinations, etc.). For example, user device 140 can be a mobile phone configured to execute application 142 to receive and display content and/or actionable elements and to receive user interaction with the content and/or actionable elements. User device 140 can also include an input/output circuit for communicating data over network 130. In some arrangements, the user device(s) 140 can include an application 142 (also referred to as provider application 142, provider mobile application 142, etc.). In some arrangements, the user device(s) 140 can execute the application 142 or another software application (e.g., web browser, locally installed application, etc.) to link or synchronize user data, exchanges, and/or accounts between providers, merchants, and users. For example, the application 142 can be configured to retrieve content from other computing systems and devices over the network 130, such as an interface and/or dashboards (e.g., from the provider exchange system 110) for displaying exchange and/or account information to a user with the user device 140. For example, application 142 can be a web browser. Additionally or alternatively, application 142 can be a mobile application executed by mobile device 140. The application 142 can be a mobile application, such as a mobile banking application, which can be downloaded from an app store, pre-installed, or hard coded into the device's memory. The application 142 can provide functionalities such as transaction management, account monitoring, funds transfer, bill payments, and financial planning tools. The application 142 can be a provider application or provider mobile application linked to provider information and/or configured to support various provider-specific functionalities. For example, the application 142 can be supported by a provider and synchronized with a user's financial institution/provider account to provide access to account balances, rewards information, transaction histories, etc. In some embodiments, the application 142 can be a mobile banking application or mobile bank app.

In the example shown, the application 142 is provided and at least partly supported by the provider institution associated with the provider exchange system 110. Thus, the application 142 may be referred to as a provider application or provider mobile application. As mentioned herein, the provider institution may provide various financial products goods and/or services. As such, the provider institution mobile application 142 may provider various financial tools, such as transaction management, account monitoring, funds transfer, bill payments, and financial planning tools, etc. In some embodiments, the provider institution mobile application 142 can be a part of a mobile banking application associated with the provider institution or a separate application.

In some arrangements, the application 142 can include a collection of software development tools contained in a package (e.g., software development kit (SDK), application programming interface (API), integrated development environment (IDE), debugger, etc.). For example, application can include an application programming interface (API) or a debugger, or an SDK that includes an API, a debugger, an IDE, and so on. In some implementations, application 142 includes one or more libraries having functions that interface with a particular system software (e.g., iOS, Android, Linux, etc.). As a further example, application 142 can include a function configured to collect and report data (e.g., exchange data, account data, merchant data, device analytics, etc.), and a user can insert the function into the instructions of application 142 to cause the function to be called during specific actions of application 142 (e.g., in response to identifying an exchange).

The provider mobile application 142 can be installed and designed to run on smartphones, tablets, and other mobile devices. The provider mobile application 142 can include a client-side application that interacts with server-side components over the network. The mobile application 142 can be implemented using various programming languages and frameworks, such as Swift or Objective-C for iOS, and Kotlin or Java for Android. The provider mobile application 142 can be packaged and distributed through app stores. In some implementations, the provider mobile application 142 can include a presentation layer (UI/UX), a business logic layer, and a data layer. The presentation layer can handle user interactions and displays data using graphical user interface components. The business logic layer can process user inputs, manages application workflows, and enforces rules and policies. The data layer can manage data storage, retrieval, and synchronization with remote servers. The provider mobile application 142 can utilize device capabilities such as cameras, GPS, accelerometers, and touchscreens. The provider mobile application 142 can operate in online or offline modes, utilizing local storage and caching mechanisms to facilitate functionality when network connectivity is limited. Security measures, such as encryption, authentication, and secure communication protocols, can be implemented to protect user data and ensure privacy.

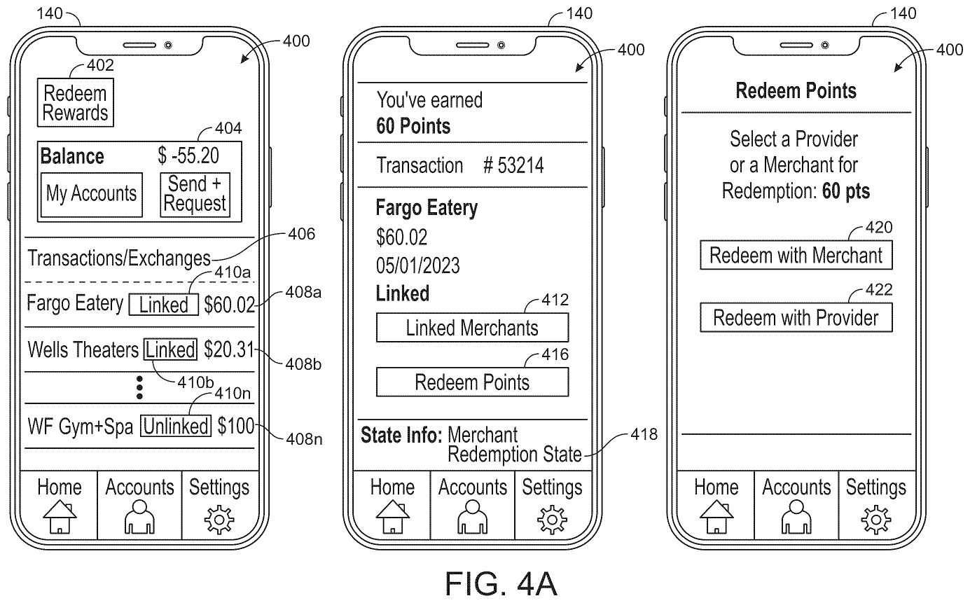

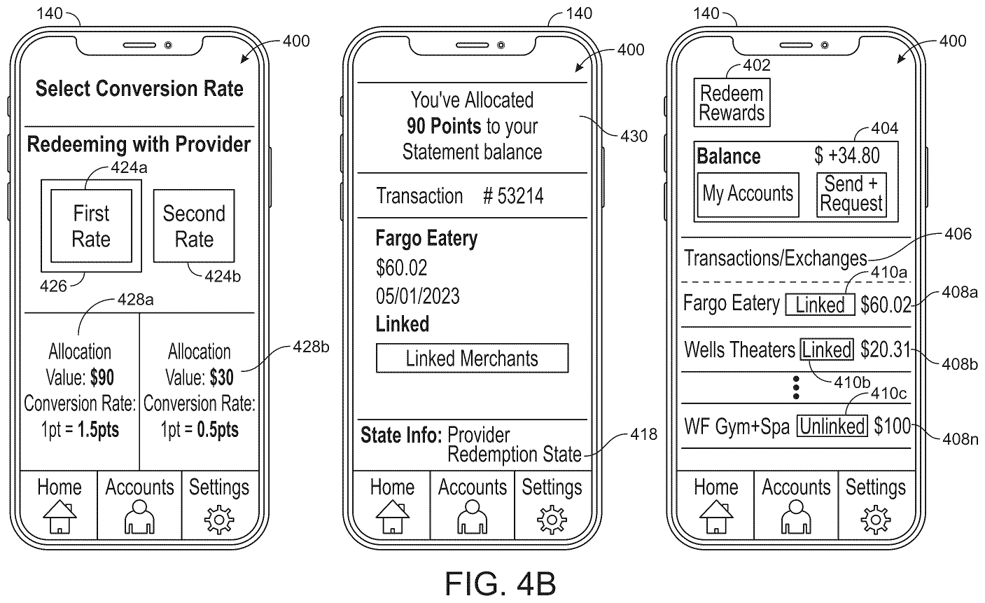

In some arrangements, the user device 140 and application 142 can be configured to provide one or more interfaces (e.g., graphical user interfaces (GUIs)). For example, the user device 140 and application 142 may generate and provide the following interfaces: an exchange interface (e.g., for accessing, viewing, or updating exchanges corresponding to a user and a provider), an account interface (e.g., for accessing, viewing, or updating accounts corresponding to a user, a provider, and various merchants), a reward interface (e.g., for accessing, viewing, or updating rewards associated with exchanges, providers, and/or merchants), a payment instrument interface (e.g., for viewing or spending with a linked payment instrument (e.g., agnostic transaction card, also referred to herein as a linked payment instrument, linked instrument, agnostic payment instrument, or agnostic instrument)), etc. For example, the exchange interface can display a history of all recent transactions (e.g., in a table format for a past predefined amount of time), accessing, viewing, and updating exchanges associated with a user's provider account. In another example, the account interface can include a provider-managed list of linked or unlinked user accounts with various merchants. In various embodiments, the provider can maintain an account (e.g., checking account, savings account, etc.) associated with a user. Further, the user may have additional accounts with other entities, such as third parties (e.g., merchants), and the provider can link the provider account of the user with various third-party accounts of the user. In yet another example, the reward (or recognition unit) interface can depict a summary of accumulated rewards for users to access, view, and update their rewards earned from transactions with different merchants and the provider. Further, the reward or recognition unit interface can include one or more content items or actionable elements corresponding to allocating (e.g., redeeming) recognition units with various merchants or with a provider according to various conversion rates (e.g., determined or identified based on one or more merchant-provider exchange parameters or provider-merchant exchange parameters). In another example, the payment instrument interface can display a digital linked payment instrument (e.g., content item or actionable element corresponding to an agnostic transaction card or credit card) to facilitate a user transferring credits or recognition units earned between one or more linked merchants to a provider (e.g., as statement credit on a provider account balance). In some arrangements, the interfaces can include various additional or alternative content items (e.g., for presenting content) and/or actionable elements (e.g., user-selectable or user-interactive features) and be presented on an application interface of application 142 presented in the viewport of mobile electronic device 140. The interfaces provided by user device 140 or application 142 can include additional and/or alternative features and/or functionalities, as further described herein. Additional details and features of application 142 are described in greater detail below reference to FIGS. 4A-4B.

In some arrangements, the user device 140 may provide and/or execute a mobile banking application. In some examples, the user device 140 may include other applications, such as a web browser application. The user device 140 can provide an interface (e.g., from the generation system 114 of the provider exchange system 110) on a viewport of the user device 140. For example, the interface can be a a banking interface of a provider mobile application 142. The mobile electronic device 140 and application 142 can receive input from an input device, such as the content system 116 of the provider exchange system 110 (e.g., a pointing device, a keyboard, a touch screen, or another form of input device). In response, one or more processors of the user device 140 executing the instructions from application 142 can request data from another device connected to the network 130 (e.g., the provider exchange system 110). The other device can then provide recognition unit data (e.g., allocation states, portions of states, etc.), exchange data, account data (e.g., linked account data or unlinked account data) and/or other data to the user device 140, which causes the interface to be presented by the viewport of the user device 140 to a user for providing information or facilitating user interaction with the interface. In some implementations, application 142 can display a graphical user interface (GUI) such as an interactable web page and/or an interactive mobile application to a user (e.g., graphical user interface (GUI) 400 of FIGS. 4A-4B).

The third-party computing system(s) 150 are associated with third-parties relative to the provider institution associated with the provider exchange system 110. As such, the third-parties may include merchants and/or other entities that may provide accounts or recognition units associated with the user. In some arrangements, the various components of the environment 100 can interact with the third party computing system(s) 150 to link various accounts (e.g., user accounts with third parties or merchants, user accounts with providers, etc.) or to allocate or redeem recognition units (e.g., rewards credits) with various linked merchants. For example, the provider exchange system 110 can provide an exchange interface or a recognition interface by accessing the third party computing system 150 (e.g., merchant computing system) using a viewport of a graphical user interface (GUI) of the application 142 of the user device 140. Further, user device 140 can present a login interface from the third party computing system(s) 150 within the application 142 such that the user can enter login credentials (e.g., username, email, phone number, password, passcode, multi-factor authentication input, etc.). Further, a user can view displayed content items and/or interact with input elements (e.g., actionable elements with content) presented on the graphical user interface of the application after accessing or communicating with the third party computing system(s) 150. In some arrangements, data used to update the content items and/or actionable elements can be received via a data communications link (e.g., network 130) between the user device 140 and the third party computing system(s) 150, or via a data communications link between the provider exchange system 110 and third party computing system(s) 150.

The provider exchange system 110 is structured or configured to synchronize recognition units of a user. In some arrangements, the provider exchange system 110 can be configured to identify multiple recognition units of the user. For example, the provider exchange system 110 can access various user accounts across different platforms through API integration to compile loyalty points, digital credits, or other forms of recognition units (e.g., provided via other computing devices connected to the network 130). In another example, the provider exchange system 110 can analyze and/or parse transaction records (e.g., exchange histories) to categorize recognition units (e.g., as merchant recognition units for redemption with a merchant, a provider recognition units for redemption with a provides, and as points, credits, or tokens from various different services). That is, the provider exchange system 110 can use algorithms to detect and aggregate these units from multiple sources into a unified user profile. In some arrangements, at least one recognition unit of the multiple recognition units corresponds to a first state of multiple states. In one example, a merchant redemption state can correspond to spendable units with the merchant, and a provider redemption state can correspond to spendable units with the provider. In some arrangements, the at least one recognition unit corresponds to at least one linked merchant of multiple linked merchants or corresponds to a provider. For example, the provider exchange system 110 can link recognition units to specific merchants (e.g., retail stores or service providers like subscription services), and the provider exchange system 110 can track and/or analyze the recognition units to determine the unit's correspondence.

In some arrangements, the provider exchange system 110 can be configured to generate one or more actionable elements with content corresponding to the at least one recognition unit. For example, the provider exchange system 110 can create interactive components within a mobile application, such as buttons or sliders, that facilitate users redeeming or transferring their recognition units (e.g., dynamically generating buttons to redeem points or credits). In some arrangements, at least one of the one or more actionable elements corresponds with a state change from the first state of the multiple states to a second state of the multiple states based on a merchant-provider exchange parameter. For example, a “Redeem” button can facilitate changing points from a “pending” state to a “redeemed” state upon the completion of a transaction, updating the backend systems through secure API calls. In some arrangements, the provider exchange system 110 can be configured to provide the one or more actionable elements to a graphical user interface (GUI) of a provider mobile application on a mobile device of the user. For example, these elements can be displayed on the user's loyalty app such that the user can interact with their points or credits directly on their smartphone. In some arrangements, the provider exchange system 110 can be configured to receive, via the GUI, a selection of the one or more actionable elements corresponding with a request to update a portion of the first state of the at least one recognition unit to the second state based on the merchant-provider exchange parameter. For example, when a user selects to “Redeem Points” within the app, the provider exchange system 110 can process the user selection and update a status or state of the recognition units from “available” (e.g., unallocated, eligible, etc.) to “used” (e.g., allocated, spent, etc.). In some arrangements, the provider exchange system 110 can be configured to update the portion of the first state of the at least one recognition unit to the second state. For example, the system can change the first state of the recognition unit from a merchant allocation state to a provider allocation state (e.g., by updating stored data stored in a database, such as database 120). In some arrangements, updating includes deducting the at least one recognition unit from a first account of the user. For example, the provider exchange system 110 can subtract or automatically deduct points from a user's loyalty account balance after points are allocated for use or used for a purchase. In some arrangements, updating can include calculating an equivalent recognition unit value based on the merchant-provider exchange parameter. For example, the provider exchange system 110 can compute the value of points in terms of currency based on a predefined exchange rate set by the merchant or service provider. In some arrangements, updating includes further updating, by the one or more processing circuits, a recognition unit value of the at least one recognition unit based on the equivalent recognition unit value. For example, in response to determining a conversation rate of 1 merchant point=1.5 provider points, the provider exchange system 110 can calculate the equivalent recognition value by multiplying the merchant credits based on the exchange rate (e.g., by 1.5) to determine a recognition unit value (e.g., total credits, allocation sum, rewards total, points balance, currency, etc.) Further, the value of the at least one recognition unit to be allocated (e.g., stored data corresponding to total points, total credits, etc.) may be updated by the provider exchange system 110 modifying, deleting from, adding to, or otherwise changing the recognition unit value to match the calculated equivalent recognition value (e.g., to align with a total number of points calculated for allocation based on the merchant-provider exchange parameter/conversion rate). In some arrangements, updating includes allocating the at least one recognition unit to a second account of the user based on the equivalent recognition unit value and the second state of the multiple states. For example, after points are redeemed, the points/recognition units can be converted into digital credits by the provider exchange system 110 based on a calculation or computation of the equivalent recognition unit value and be further added to the user's balance (e.g., provider transaction card balance) within the application in response to determining the second state is the provider redemption state. For example, the equivalent recognition value can include the calculated or determined value of the at least one recognition unit when the recognition unit is redeemed and/or allocated (e.g., for spending) with the provider based on the provider-merchant exchange parameter.

In some arrangements, the provider exchange system 110 can be configured to establish a data communications link with a merchant computing system of at least one linked merchant. For example, the provider exchange system 110 can establish or use API connections to communicate with the merchant's servers to facilitate data synchronization of user accounts, transactions, and corresponding recognition units. In some arrangements, the provider exchange system 110 can be configured to modify, via the data communications link, stored data corresponding to the multiple recognition units based on updating the first state of the multiple states into the second state of the multiple states. For example, once points are redeemed, the provider exchange system 110 can update the user's account within a merchant loyalty program and the merchant's database to reflect the new status of these points (e.g., changing the points'state from “a merchant state” to “a provider state”). In some arrangements, the provider exchange system 110 can be configured to update the content of the one or more actionable elements corresponding with a successful conversion of the first state to the second state. For example, after the points are used/allocated (e.g., to the provider), the provider exchange system 110 can update or modify an interface or other display of the application to the points have been redeemed (e.g., displaying a confirmation message in the app). In some arrangements, the provider exchange system 110 can be configured to provide the updated content of the one or more actionable elements to the GUI of the provider mobile application. For example, the provider exchange system 110 can provide the updated content to the application 142, which can refresh user/provider balance data and/or display an updated status of the recognition units in response to user input via the GUI (e.g., converting to a provider redemption state).

In some arrangements, the provider exchange system 110 can be configured to receive, via the GUI, a selection of the one or more actionable elements corresponding with a request to update a portion of the first state of the at least one recognition unit to the second state based on the merchant-provider exchange parameter. For example, the provider exchange system 110 can present a “Redeem” option within a mobile app, which, upon user selection, triggers the provider exchange system 110 to process the conversion of loyalty points from an “accrued” state to a “redeemed” state. In some arrangements, the provider exchange system 110 can be configured to update the portion of the first state of the at least one recognition unit to the second state. For example, the provider exchange system 110 can automatically change points from a “pending” status to a “used” status after the completion of a transaction. In some arrangements, updating includes deducting the at least one recognition unit from a first account of the user. For example, when a user redeems points for a purchase, the provider exchange system 110 can decrease the points balance in the user's loyalty account accordingly. In some arrangements, updating includes the provider exchange system 110 calculating an equivalent recognition unit value based on the merchant-provider exchange parameter. For example, the provider exchange system 110 can convert a predefined number of points (e.g., 1000 points, 2 recognition units, a recognition unit with a value of one or more points, a recognition unit with a value of one or more dollars, etc.) into a corresponding monetary value or other unit of value for the transaction. In some arrangements, updating includes allocating the at least one recognition unit to a second account of the user based on the equivalent recognition unit value and the second state of the multiple states. For example, after the redemption of points, the provider exchange system 110 can transfer the equivalent value into a digital gift card or store credit account, thus providing the user with a balance that can be utilized for future purchases.

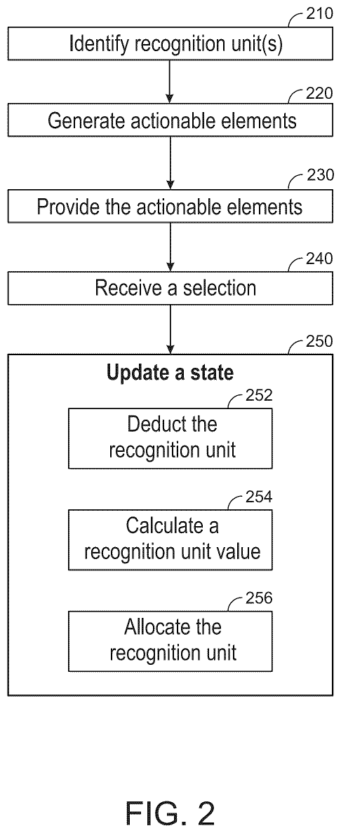

In some arrangements, the provider exchange system 110 can further include one or more systems (e.g., identification system 112, generation system 114, content system 116, allocation system 118, etc.) for synchronizing recognition units between a merchant and a provider and/or for incorporating the various features and/or functionalities described herein (e.g., for performing one or more steps of method 200 of FIG. 2). In some arrangements, the identification system 112 can identify multiple recognition units of the user. For example, the identification system 112 can scan through different user accounts across various platforms via API integration to compile loyalty points, digital credits, or other types of recognition units (e.g., points from retail stores, credits from service providers, or tokens from financial institutions). In another example, the identification system 112 can analyze and/or parse transaction records (e.g., exchange histories) to categorize recognition units based on their usage and origin (e.g., as merchant recognition units for use with specific merchants, provider recognition units for use with service providers, and general points or credits for various services). That is, the identification system 112 can implement algorithms to detect and aggregate these units from multiple sources into a cohesive user profile, facilitating a unified view and management of the user's rewards. In some arrangements, at least one recognition unit of the multiple recognition units corresponds to a first state of multiple states. For example, a recognition unit can be in an “available” state, ready for immediate redemption, in a “pending” state awaiting processing or confirmation, or in a “redeemed” state, indicating that the unit has already been utilized. In some arrangements, the at least one recognition unit corresponds to at least one linked merchant of multiple linked merchants or corresponds to a provider. For example, the identification system 112 can track units that are linked to specific merchants (e.g., loyalty points from grocery stores or service credits from telecom providers) and determine their association, providing accurate synchronization and utilization within the provider exchange system 110.

In some arrangements, the generation system 114 can generate one or more actionable elements with content corresponding to the at least one recognition unit. For example, the generation system 114 can create actionable elements such as buttons, dropdown menus, or links within a mobile application for users to manage their recognition units (e.g., generating options to “Redeem,” “Transfer,” or “Convert” points or credits). In some arrangements, at least one of the one or more actionable elements corresponds with a state change from the first state of the multiple states to a second state of the multiple states based on a merchant-provider exchange parameter. For instance, the generation system 114 can configure a “Redeem” button to change the state of points from “accrued” to “redeemed” once the user completes a transaction or uses the points for a purchase. In some arrangements, the provider exchange system 110 can be configured to provide the one or more actionable elements to a graphical user interface (GUI) of a provider mobile application on a mobile device of the user. For example, the generation system 114 can display these elements on the user's banking or loyalty program app such that user can interact with recognition units through the an interface of the application 142.

In some arrangements, the content system 116 can receive, via the GUI, a selection of the one or more actionable elements corresponding with a request to update a portion of the first state of the at least one recognition unit to the second state based on the merchant-provider exchange parameter. For example, the content system 116 can detect when a user selects an option such as “Redeem Points” in the mobile app, triggering a backend process to update the state of the points (e.g., from a merchant redemption state to a provider redemption state, etc.) In another example, the content system 116 can process user inputs to transfer or convert recognition units, such as moving points from one type of account to another or changing a status or state from “provider” to “merchant.” In another example, the content system 116 can process a user request (e.g., selection of elements) via the graphical user interface and further initiate corresponding updates within the provider exchange system 110.

In some arrangements, the allocation system 118 can update the portion of the first state of the at least one recognition unit to the second state. For example, the allocation system 118 can automatically change the status of points from “earned” to “spent” after the user redeems them. In some arrangements, updating includes the allocation system 118 deducting the at least one recognition unit from a first account of the user. For example, if the user utilizes points for a purchase, the allocation system 118 can decrease the points balance in the user's loyalty account to reflect the redemption. In some arrangements, updating includes calculating an equivalent recognition unit value based on the merchant-provider exchange parameter. For example, the allocation system 118 can convert a predefined number of points (e.g., 1000 points, 2 recognition units, a recognition unit with a value of one or more points, a recognition unit with a value of one or more dollars, etc.) into a corresponding monetary value or other unit of value for the transaction. In some arrangements, updating includes allocating the at least one recognition unit to a second account of the user based on the equivalent recognition unit value and the second state of the multiple states. For example, after the points are redeemed, the allocation system 118 can transfer the equivalent value into a digital gift card or store credit account such that the user can utilize these credits for future purchases/exchanges.

Referring now to FIG. 2, a flowchart for a method that can be implemented or performed by one or more components/systems of FIG. 1 is shown, according to some arrangements. At least provider exchange system 110 of FIG. 1 can be configured to perform method 200. In some arrangements, the steps or blocks of method 200 can be executed sequentially or in parallel (e.g., block 220 and block 230 can be performed in parallel). It should be understood that in other embodiments, the steps may be performed in another order, combined, and/or additional modifications implemented, such as the deletion of one or more steps and/or the addition of one or more steps.

In a broad overview of method 200 (implementing the synchronization architecture), at block 210, the one or more processing circuits (e.g., provider exchange system 110 in FIG. 1) can identify recognition unit(s). At block 220, the provider mobile application 142 can generate actionable elements. At block 230, the provider mobile application 142 can provide the actionable elements. At block 240, the provider mobile application 142 can receive a selection of the actionable elements. At block 250, the provider exchange system 110 can update a state. At block 252, the provider exchange system 110 can deduct a recognition unit. At block 254, the provider exchange system 110 can calculate a recognition unit value. At block 256, the provider exchange system 110 can allocate the recognition unit.

In some arrangements, at block 210, the one or more processing circuits (e.g., provider exchange system 110 in FIG. 1) can identify recognition unit(s). In some arrangements, at block 210, the one or more processing circuits can identify multiple (e.g., at least one, one or more, etc.) recognition units of the user. For example, the provider exchange system 110 can query various user accounts across different platforms via API integration to compile information on loyalty points, digital credits, or reward units. In an example, the provider exchange system 110 can access databases associated with multiple merchants and service providers to retrieve data on the user's accumulated points or credits. Another example includes the provider exchange system 110 parsing transaction histories to recognize and classify recognition units based on their type and source (e.g., distinguishing between points earned from retail purchases and credits awarded by service subscriptions). Additionally, the provider exchange system 110 can use machine learning (ML) models to detect patterns in user behavior that correlate with the earning or redemption of recognition units, facilitating the automatic identification and aggregation of these units into a unified profile. In some arrangements, at least one recognition unit of the multiple recognition units corresponds to a first state of multiple states. For example, a recognition unit can be in an “available” state, indicating it is ready for use, in a “pending” state, awaiting validation or processing, or in a “redeemed” state, signifying it has already been utilized. In another example, the state can be “earned” for newly acquired points or “expired” for points that are no longer valid. In some arrangements, the at least one recognition unit corresponds to at least one linked merchant of multiple linked merchants or corresponds to a provider. For example, the provider exchange system 110 can identify points associated with retail stores, making them usable at those specific locations, or credits tied to a provider, such as subscription credits applicable towards reducing service fees. In another example, the provider exchange system 110 can track units specifically linked to online merchants, offering options for their use during digital shopping experiences.

In some arrangements, at block 220, the one or more processing circuits (e.g., provider exchange system 110 in FIG. 1) can generate actionable elements. In some arrangements, at block 220, the one or more processing circuits can generate one or more actionable elements with content corresponding to the at least one recognition unit. For example, the provider exchange system 110 can create interactive UI components like buttons, links, or dropdown menus within a mobile application, facilitating the management of recognition units by users (e.g., generating a “Redeem Points” button that initiates the points conversion process). In another example, the provider exchange system 110 can generate detailed options in a loyalty wallet interface for users to select how to use their points, such as converting the points to credit, transferring to another account, or redeeming for discounts on purchases. In an example, the provider exchange system 110 can create a dynamic slider bar that lets users adjust the amount of points they want to redeem, displaying the equivalent monetary value as they move the slider. In some arrangements, at least one of the one or more actionable elements corresponds with a state change from the first state of the multiple states to a second state of the multiple states based on a merchant-provider exchange parameter. For example, selecting a “Convert to Credit” button can cause the provider exchange system 110 to change the points'status from “available” to “converted” once the points are used to offset a statement balance with the provider. This conversion process can include updating the recognition unit's status in the backend systems, ensuring the new state and value are reflected accurately.

In some arrangements, at block 230, the one or more processing circuits (e.g., provider mobile application 142) can provide the actionable elements. In some arrangements, at block 230, the provider mobile application 142 can provide the one or more actionable elements to a graphical user interface (GUI) of a provider mobile application on a mobile device of the user. For example, the provider exchange system 110 can render these actionable elements within the app's user interface, presenting options like redeeming or transferring points directly on the user's smartphone or tablet. In another example, the GUI can be designed to integrate with the provider's mobile app, showing elements such as “Redeem for Cash Back”, “Convert to Statement Credit”, “Perform Account Adjustments”, “Convert to Reward Points”, “Redeem Loyalty Units”, “Obtain Bonus Credits” buttons on the app's main screen. In an example, the provider mobile application 142 can provide a GUI including a dedicated “Loyalty Wallet” section where users can view and manage their aggregated recognition units from different accounts, performing actions like redemption or conversion through intuitive controls. The provider mobile application 142 be configured to provide real-time updates and feedback (e.g., to display a user balance after an action is taken).

In some arrangements, at block 240, the one or more processing circuits (e.g., provider mobile application 142) can receive a selection. In some arrangements, at block 240, the provider mobile application 142 can receive, via the GUI, a selection of the one or more actionable elements corresponding with a request to update a portion of the first state of the at least one recognition unit to the second state based on the merchant-provider exchange parameter. For example, the provider exchange system 110 can detect when a user selects a “Redeem” button in the mobile app, initiating a request to change the state of points from “accrued” to “redeemed.” In another example, the provider exchange system 110 can process user input when they choose to convert points into a monetary equivalent for a credit (e.g., as provider statement credits, account adjustments, reward points, loyalty units, bonus credits, and/or any other reward mechanism), triggering the backend system to update the points'state accordingly. In an example, the system can capture a user's selection from a dropdown menu to specify the amount of points they want to convert, prompting the provider exchange system 110 to process this request and adjust the points'state from “pending” to “completed.” This process can include processing the user's interaction through the interface and executing the various updates within the provider exchange system 110.

In some arrangements, at block 250, the one or more processing circuits (e.g., provider exchange system 110) can update a state. In some arrangements, at block 250, the one or more processing circuits can update the portion of the first state of the at least one recognition unit to the second state. For example, the provider exchange system 110 can transition points from an “earned” state to a “redeemed” state after the user applies them towards a purchase or conversion. In another example, the provider exchange system 110 can update the status of credits from “available” to “used” when they are applied to offset a provider's statement balance. In an example, the system can change the recognition units'state from “pending” to “active” after validation processes are completed, ensuring that the units are ready for use in future transactions. This update process ensures that the new state of the recognition units is accurately reflected in both the user's account and the associated merchant or provider systems.

In some arrangements, at block 252, the one or more processing circuits (e.g., provider exchange system 110) can deduct the recognition unit. In some arrangements, at block 252, updating includes the provider exchange system 110 deducting the at least one recognition unit from a first account of the user. For example, the provider exchange system 110 can subtract points from the user's loyalty account balance once they are redeemed for a purchase or conversion. In another example, the provider exchange system 110 can deduct digital credits from the user's provider account after they are converted into a credit or any other reward mechanisms described herein. In an example, the provider exchange system 110can automatically adjust the user's account to reflect the spent units, deducting them from the available balance to prevent further use until new points are earned or acquired.

In some arrangements, at block 254, the one or more processing circuits (e.g., provider exchange system 110) can calculate a recognition unit value. In some arrangements, at block 254, updating includes provider exchange system 110 calculating an equivalent recognition unit value based on the merchant-provider exchange parameter. For example, the provider exchange system 110 can convert a predefined number of points (e.g., 1000 points, 2 recognition units, a recognition unit with a value of one or more points, a recognition unit with a value of one or more dollars, etc.) into a corresponding monetary value based on the current exchange rate provided by the merchant or provider. In another example, the provider exchange system 110 can calculate the value of service credits in terms of their worth for a credit, adjusting the value according to the predefined parameters set by the merchant-provider agreement. In an example, the system can dynamically compute the conversion rates for different types of recognition units, providing the user with the most favorable value options during the redemption or conversion process. In some arrangements, at block 254, the one or more processing circuits (e.g., provider exchange system 110) can further update a recognition unit (e.g., of the at least one recognition unit). In some arrangements, at block 254, updating at block 250 may include further updating, by provider exchange system 110, a recognition unit value of the at least one recognition unit based on the equivalent recognition unit value. For example, in response to determining a conversation rate of 1 merchant point=0.75 provider points, the provider exchange system 110 can calculate the equivalent recognition value by multiplying the merchant credits based on the exchange rate (e.g., by 0.75) to determine a recognition unit value (e.g., total credits, allocation sum, rewards total, points balance, currency, etc.). Further, the value of the at least one recognition unit to be allocated (e.g., stored data corresponding to total points, total credits, etc.) may be updated by the one or more processing circuits modifying, deleting from, adding to, or otherwise changing the recognition unit value to match the calculated equivalent recognition value (e.g., to align with a total number of points calculated for allocation based on the merchant-provider exchange parameter/conversion rate). For example, if a user initially accrued 100 points corresponding to a merchant allocation state and converts the points to provider credit at a ratio of 1 merchant point=0.75 provider points, the equivalent recognition unit value can be calculated as 75 points or $75 (e.g., using a points to currency ratio of one dollar=one point, etc.). Further, the one or more processing circuits may update stored data indicative of the value of the recognition unit (e.g., initially 100 points or $100) after updating the recognition unit value according to the equivalent recognition value (e.g., the initial 100 points spendable with a merchant being converted to 75 points spendable with a provider by updating corresponding states).

In some arrangements, at block 256, the one or more processing circuits (e.g., provider exchange system 110) can allocate the recognition unit. In some arrangements, at block 256, the provider exchange system 110 can allocate the at least one recognition unit to a second account of the user based on the equivalent recognition unit value and the second state of the multiple states. For example, after converting points to a credit, the provider exchange system 110 can transfer the equivalent monetary value into the user's account with the provider, such as a credit card or loan account, where the credit can be applied. In another example, the provider exchange system 110 can allocate the redeemed points to a digital gift card balance or store credit account, making the equivalent value available for future purchases. In an example, the system can update the user's digital wallet to reflect the new balance of credits or points, ensuring they are accessible for use in subsequent transactions with the provider or linked merchants. The allocation process can include updating the user's accounts to reflect the new balance and state of the recognition units, ensuring that the converted value is accurately applied and available for use.

In some arrangements, the provider exchange system 110 can further establishing a data communications link with a merchant computing system of at least one linked merchant. For example, the provider exchange system 110 can implement an OAuth-based secure authentication framework to facilitate data exchange between the user's account and the merchant's computing system, facilitating controlled and secure access to user data (e.g., utilizing token-based authentication to grant temporary access permissions for data transactions). In another example, the provider exchange system 110 can employ a Virtual Private Network (VPN) connection to create a secure communication channel between the merchant's system and the provider exchange system 110, providing encrypted data transfer to protect sensitive information (e.g., configuring a VPN with encryption protocols like IPsec or TLS to safeguard data as it moves across the network). In some arrangements, the provider exchange system 110 can modify, via the data communications link, stored data corresponding to the multiple recognition units based on updating the first state of the multiple states into the second state of the multiple states. For example, when the user redeems points for a digital credit, the one or more processing circuits can update the merchant's ledger to reflect the change in status from “accrued” to “redeemed,” ensuring that the recognition units'new state is accurately recorded (e.g., executing a database transaction to modify the status field of the recognition units from ‘active’ to ‘used’). In another example, the provider exchange system 110 can synchronize the user's recognition unit balance by modifying stored records on both the merchant and the provider's systems, ensuring consistency after a state change (e.g., updating SQL tables in both databases to reflect the new state and balance of the recognition units). In some arrangements, the provider exchange system 110 can update the content of the one or more actionable elements corresponding with a successful conversion of the first state to the second state. For example, once the points are converted from “pending” to “redeemed,” the provider exchange system 110 can update the user interface to display the new status and balance of the points, providing immediate feedback to the user (e.g., dynamically refreshing the GUI to show the updated points balance and conversion status in real-time). In another example, the provider exchange system 110 can update the display of available actions in the app to reflect the completed conversion, such as changing a “Redeem Points” button to a “Transaction Complete” status (e.g., altering the user interface elements to indicate the successful completion of the points redemption process). In some arrangements, the provider exchange system 110 can provide the updated content of the one or more actionable elements to the GUI of the provider mobile application. For example, the updated information about the recognition units'new state can be displayed on the user's mobile app such that the user can view or see the effects of a transaction, exchange, or allocation immediately (e.g., showing the adjusted points balance and recent transaction history on the app's main screen). In another example, the provider exchange system 110 can push the updated content to the app in real-time, using push notifications or real-time data synchronization techniques to keep the user informed about their points and conversions (e.g., using a WebSocket connection to send real-time updates to the app's interface, ensuring that the user always has the most current data).

In some arrangements, the provider exchange system 110 can further receive exchange data for an exchange between the user and at least one linked merchant facilitated by the provider, the exchange data including the merchant-provider exchange parameter. For example, the provider exchange system 110 can receive transaction details when a user initiates a points redemption or conversion through the provider's platform (e.g., receiving data packets containing information about the number of points to be redeemed and the associated conversion rate from the merchant's system). In another example, the provider exchange system 110 can gather exchange data via a secure API call that transmits the specifics of the user's transaction, including the amount of recognition units and the conditions of the exchange (e.g., collecting detailed parameters about the points-to-currency conversion rate offered by the merchant). In some arrangements, the provider exchange system 110 can identify, in response to receiving the exchange data, at least one first state change option of multiple state change options, the at least one first state change option corresponding to the state change from the first state of the multiple states to the second state of the multiple states. For example, upon receiving the exchange data, the provider exchange system 110 can analyze the provided information to determine the available options for changing the state of the recognition units from “accrued” to “redeemed” or “converted” (e.g., evaluating different conversion paths based on the exchange parameters and selecting the most suitable state transition for the units). In another example, the provider exchange system 110 can identify multiple potential actions that the user can take with their recognition units, such as transferring them to another account, redeeming them for a discount, or converting them into a credit (e.g., as provider statement credits, account adjustments, reward points, loyalty units, bonus credits, and/or any other reward mechanism—presenting the user with a menu of options that reflect various state changes based on the exchange data).

In some arrangements, identifying the at least one first state change option further includes determining at least one second state change option of the multiple state change options, the at least one second state change option comprising at least one second merchant-provider exchange parameter. For example, the provider exchange system 110 can evaluate alternative options for converting recognition units into different types of value, such as choosing between converting points into a digital gift card or using them for a service credit (e.g., analyzing different merchant-provider exchange rates to determine the best value for the user's points). In another example, the provider exchange system 110 can compare the benefits of various state changes, like deciding whether to redeem points immediately or to wait for a more favorable conversion opportunity based on changing market conditions (e.g., assessing the potential future value of points under different exchange scenarios). In some arrangements, the provider exchange system 110 can further model a first exchange rate based on the merchant-provider exchange parameter and a second exchange rate based on the second merchant-provider exchange parameter. For example, the provider exchange system 110 can calculate the equivalent monetary value of points under different exchange rates provided by multiple merchants, determining which rate offers the highest return for the user (e.g., simulating conversions using both current and projected exchange rates to evaluate the potential outcomes for the user's recognition units). In another example, the provider exchange system 110 can use historical data to model and predict future exchange rates, providing insights into the best times to convert points for maximum value (e.g., leveraging machine learning algorithms to forecast exchange rate trends and suggest optimal conversion times based on past data patterns). In some arrangements, the provider exchange system 110 can further determine a preferred exchange rate based on the modeled first exchange rate and the modeled second exchange rate. For example, after comparing the potential returns from different exchange rates, the provider exchange system 110 can recommend the rate that offers the best value to the user (e.g., selecting the highest conversion rate available at the time and suggesting it as the preferred option for the user's transaction). In another example, the provider exchange system 110 can automatically select the most advantageous rate for the user and proceed with the conversion, ensuring that the user receives the maximum possible benefit from their recognition units (e.g., dynamically adjusting the conversion process to utilize the most favorable exchange rate identified by the system).

In some arrangements, the application 142 can further generate at least one indication element including content indicating the preferred exchange rate. For example, the provider application 142 can create visual indicators within the user interface, such as icons or messages that highlight the recommended exchange rate for converting recognition units (e.g., displaying a “Best Value” badge next to the suggested conversion rate). In another example, the application 142 can generate tooltip or popup information that explains why a particular rate is preferred, providing users with detailed insights into their conversion options (e.g., showing a comparative analysis of different rates and highlighting the benefits of the recommended option). In some arrangements, the application 142 can further update the content of the one or more actionable elements to include the at least one indication element, wherein updating includes grouping the at least one indication element with the preferred exchange rate. For example, the application 142 can update the user interface to group the preferred exchange rate and the corresponding action button together, making it easy for users to select the best option (e.g., placing the “Redeem Now” button alongside the recommended rate and an explanation of its benefits). In another example, the application 142 can modify the layout of the actionable elements to prioritize the preferred exchange rate, such as arranging conversion options in order of value and emphasizing the top choice (e.g., using bold text or highlighted backgrounds to draw attention to the preferred rate). In some arrangements, the provider exchange system 110 can further include provide the updated content of the one or more actionable elements to the GUI in a viewport of the provider mobile application 142. For example, the updated elements can be displayed prominently within the app's main interface, ensuring that users can easily see and access the preferred exchange options (e.g., featuring the updated content at the top of the screen or within a section for recommending conversion or allocation). In another example, the provider mobile application 142 can push the updated elements to the app in real-time, using data synchronization techniques to keep the user's interface current with the latest recommendations and options (e.g., employing push notifications or live updates to refresh the displayed content whenever new preferred rates are identified).

In some arrangements, the provider mobile application 142 can further generate, in response to identifying at least one state change option, a first recognition unit of a first type based on the at least one recognition unit and the merchant-provider exchange parameter, wherein the first type is a merchant recognition unit type assignable for exchanges between the user and at least one merchant of the multiple linked merchants. For example, the provider exchange system 110 can create new points that are specifically designated for use with a particular merchant for users to redeem these points directly at the merchant's locations (e.g., generating store credits that can only be spent at a specific retailer or franchise). In another example, the provider exchange system 110 can issue digital vouchers that represent a certain value of recognition units, which can be used for purchases or services with the linked merchant (e.g., creating digital coupons that users can redeem for discounts or free items at participating merchants). In some arrangements, the provider exchange system 110 can further link the first recognition unit of the first type with the first account of the user, wherein the first account of the user corresponds to at least one linked merchant of the multiple linked merchants. For example, the provider exchange system 110 can associate the newly generated merchant-specific points with the user's loyalty account at the corresponding merchant, ensuring that the points are available for use when the user makes a purchase (e.g., adding the points to the user's account balance in the merchant's loyalty program). In another example, the provider exchange system 110 can update the user's account records to reflect the addition of the new recognition units, facilitating their use in future transactions with the linked merchant (e.g., updating the account metadata to include the new points and their applicable usage conditions). In some arrangements, the provider exchange system 110 can generate a second recognition unit of a second type based on the at least one state change option and the merchant-provider exchange parameter, wherein the second type is a provider recognition unit type assignable for one or more provider exchanges between the user and the provider. For example, the provider exchange system 110 can create credits that are valid for use with the provider, such as credits that reduce the user's outstanding balance with the provider (e.g., generating account credits that can be applied to lower the user's monthly service charges or loan payments). In another example, the provider exchange system 110 can issue points that are specifically designated for redemption with the provider's services, allowing users to apply these points towards their bills or subscriptions (e.g., creating service credits that users can use to offset costs for utilities, internet, or streaming services). In some arrangements, the provider exchange system 110 can further link the second recognition unit of the second type with the second account of the user, wherein the second account of the user corresponds to the provider. For example, the provider exchange system 110 can add the newly generated provider-specific credits to the user's account with the provider, making them available for use in reducing the user's financial obligations (e.g., applying the credits to the user's account balance in the provider's billing system). In another example, the provider exchange system 110 can update the user's account information to reflect the addition of the new provider recognition units, facilitating the application allocating future transactions or payments with the provider (e.g., modifying the user's account details to include the new credits and their respective usage terms).

In some arrangements, allocating further includes linking, by the provider exchange system 110, the first recognition unit of the first type with the first account of the user based on the merchant-provider exchange parameter, wherein the first account of the user corresponds to at least one linked merchant of the multiple linked merchants. For example, the provider exchange system 110 can link store-specific points to the user's retail account at a particular merchant, facilitating point usage directly in-store or online (e.g., synchronizing the points with the user's membership or loyalty card at the retailer). In another example, the provider exchange system 110 can allocate these points to a digital wallet that is integrated with the merchant's payment system for efficient redemption during checkout (e.g., linking the points to a digital payment app that supports the merchant's rewards program). In some arrangements, the provider exchange system 110 can further generate a second recognition unit of a second type based on the at least one recognition unit and the merchant-provider exchange parameter, wherein the second type is a provider recognition unit type. For example, the provider exchange system 110 can convert merchant-specific points into provider-specific credits that can be used to offset service charges or reduce outstanding bills with the provider (e.g., transforming points from a retail loyalty program into credits that lower the user's monthly telecom bill). In another example, the provider exchange system 110 can generate credits that are valid across multiple providers so users can apply these credits towards various services such as utilities, financial services, or digital subscriptions (e.g., creating universal credits that users can use to pay for different types of services offered by the provider).

In some arrangements, the first state is a merchant redemption state. For example, in the merchant redemption state, recognition units (such as loyalty points or reward credits) can be used directly at participating retail merchants to purchase goods or services (e.g., using points earned from shopping to get discounts or free products at the same or affiliated stores). In another example, these points can be applied towards exclusive offers or promotional discounts that are only available through the merchant's loyalty program (e.g., redeeming points for special limited-time discounts on select merchandise). In some arrangements, the second state is a provider redemption state. For example, in the provider redemption state, recognition units can be converted into credits that reduce the user's financial obligations with a service provider (e.g., transforming retail points into credits that lower monthly utility bills or service fees). In another example, these credits can be applied towards subscriptions or recurring charges from the provider, effectively reducing the user's ongoing costs for services like internet, streaming, or financial services (e.g., applying points to offset monthly subscription fees for streaming services). In some arrangements, the first account is a merchant account of the user with at least one linked merchant. For example, this merchant account can be the user's membership or loyalty account within a retailer's system, where the user accrues points or rewards through purchases and engagements (e.g., a loyalty program account that tracks points earned from buying groceries or clothing). In another example, the merchant account can be linked to a digital wallet or app that integrates with the merchant's loyalty program, allowing users to manage their rewards and redemption activities directly from their mobile device (e.g., an app-based loyalty card that accumulates points and provides real-time balance updates). In some arrangements, the second account is a provider account of the user with the provider. For example, this provider account can be the user's billing account with a service provider, where credits are applied to reduce the outstanding balance for services rendered (e.g., an account with an internet service provider where points can be used to lower monthly charges). In another example, the provider account can be an online account with a financial institution where the user's credits are converted into credits, reducing the amount due on their credit card or loan (e.g., using points to offset the principal or interest payments on a loan, applying provider statement credits to reduce service fees, using reward points for account adjustments, redeeming loyalty units for monthly subscription discounts, applying bonus credits towards utility bills, or converting points to any other reward mechanism).

In some arrangements, the first state is a provider redemption state. For example, in the provider redemption state, recognition units (such as service credits or reward points) can be used to offset costs or charges associated with the provider's services (e.g., using credits to lower utility bills or reduce interest charges on a loan). In another example, these units can be applied towards paying for subscription services or other recurring charges, effectively minimizing the user's financial obligations with the provider (e.g., applying credits to cover monthly fees for digital content or cloud services). In some arrangements, the second state is a merchant redemption state. For example, in the merchant redemption state, recognition units can be converted into loyalty points or store credits that are redeemable at participating retail merchants (e.g., converting service credits into store vouchers that can be spent on groceries or household items). In another example, these points can be used to access exclusive deals or discounts offered through the merchant's loyalty program, providing additional value to the user (e.g., using converted points to get special pricing on products during a sale event). In some arrangements, the first account is a provider account of the user with the provider. For example, this provider account can be the user's service account with a provider, where the user accumulates credits or rewards that can be used to reduce their service charges (e.g., an account with a telecom provider where points reduce the monthly bill). In another example, the provider account can be linked to a financial product, such as a credit card or loan, where the credits are used to lower the overall balance or interest costs (e.g., applying credits to reduce the interest owed on a loan). In some arrangements, the second account is a merchant account of the user with at least one linked merchant. For example, this merchant account can be the user's loyalty account with a retailer, where the user earns points through purchases that can be redeemed for future discounts or freebies (e.g., a store rewards account that tracks points earned from shopping). In another example, the merchant account can be integrated into a digital wallet for users to manage their points and redemption options across multiple merchants from a single platform (e.g., a mobile app that consolidates rewards from various stores and provides redemption options).

In some embodiments, the various methods described herein (e.g., method 200, method for synchronizing a plurality of recognition units) can include various additional and/or alternative steps. For example, the provider exchange system 110 can identify favorable conversion opportunities for the plurality of recognition units. Here, the identification can be based on real-time exchange rates (e.g., merchant-provider exchange parameters) provided by the linked merchants and the financial institution provider. For example, the provider exchange system 110 can analyze various environmental data or other information (e.g., entity data, provider data, linked merchant data, exchange parameter data, conversion rate data, etc.) and notify the user via the graphical user interface (GUI) of the provider mobile application about favorable conversion opportunities (e.g., allocation options, a plurality of state change options, etc.) to improve the user's ability to redeem recognition units at advantageous rates (e.g., at a higher rate as a credit with a provider vs. at a lower rate with an earning merchant). The provider application 142 can provide a GUI for sending a notification indicating the user to take action in response to various conditions (e.g., when the value of converting loyalty rewards, such as travel miles or retail points, is at a maximum or peak). In another example, the provider exchange system 110 can automatically implement identified favorable conversions (e.g., state change options) based on the user setting various preferences (e.g., preferences for automatic conversion within the provider's mobile application). For example, automatic implementation can include updating the user's account to reflect the new recognition unit values converted at the identified favorable rates.

In another example, the system can determine, identify, or detect beneficial or ideal (e.g., maximum, minimum, etc.) exchange rate for converting merchant rewards points into financial institution credits or financial institution credits into merchant rewards point (e.g., automatically, in response to a user request/user input, etc.). For example, the application 142 can receive user input through the GUI indicating a request to convert a specific number of merchant recognition units into statement recognition units (or any other type of recognition units such as reward recognition units, loyalty recognition units, bonus recognition units, point recognition units), and/or to convert a first state of a recognition unit of a first type into a second state, etc. The provider exchange system 110 can further verify the eligibility of requested units (e.g., for allocation, for conversion, etc.) based on the criteria set by the provider and the agreements with the merchants (e.g., one or more provider merchant exchange parameters). Upon successful verification, the provider exchange system 110 can update the user's account to reflect the converted recognition unit balance. For example, the user can choose to convert a set number of loyalty points from a retail merchant into financial institution rewards, and this request can processed after verifying the request meets certain eligibility requirements stipulated in a conversion agreement or merchant-provider exchange parameter (e.g., the user having a certain rewards status, the user spending a predefined amount within a certain time period, etc.).

It should be understood that recognition units and states of recognition units described herein include provider statement credits, account adjustments, reward points, loyalty units, bonus credits, and/or any other reward mechanism. It is contemplated that these recognition units can be converted or allocated across various platforms and providers, offering technical benefits such as enhanced data synchronization, improved computational efficiency, and reduced latency in exchange processing. The systems and methods facilitate integration and interoperability between different reward mechanisms, providing an improved technical configure to manage and convert rewards, which leads to a more efficient use of system resources and improved user experience. Each type of recognition unit and state can have distinct characteristics and conversion criteria. For example, loyalty units earned from retail purchases can have specific expiration dates and can be converted into provider statement credits at a set rate. In another example, reward points accumulated through credit card usage can be transferred to a merchant's loyalty program for use as store credits. In yet another example, bonus credits awarded during promotional periods can be subject to special terms and can be redeemed only under certain conditions, such as a minimum purchase requirement. In yet another example, bank statement credits earned from financial institution promotions can be used to offset monthly banking fees or loan payments.

In some arrangements, the provider exchange system 110 can track the balance and expiration dates of the recognition units across various linked merchants. For example, tracking can be facilitated through the provider's mobile application, and the provider exchange system 110 can provide or recommend state change option or opportunities (e.g., conversions) for units nearing expiration dates (e.g., to prevent the loss of rewards). In an example, if the system detects that a user's rewards points from a specific merchant are about to expire, it can suggest converting these points into credits, thereby preserving the value and utility of the rewards points for the user. In addition, the provider exchange system 110 can further provide actionable elements through the GUI (e.g., interface for the provider exchange system 110 to display options, content, and/or input for the user to select desired conversion rates or redemption preferences). For example, the provider exchange system 110 can generate and/or provide a menu or interface where the user can choose to convert their rewards points into different forms, such as credits or direct deposits into various financial accounts. Further, the processing provider exchange system 110 can receive the user selections and execute desired conversions according to the selected actionable elements, input devices, or other options. For example, a user can decide to transfer their accumulated points from several merchants into a unified financial institution account for improved and/or centralized management.

In some arrangements, the provider exchange system 110 can establish a data communications link with the provider's financial system to synchronize the updated recognition unit balances after conversion. In one example, the synchronization process can generating a report (e.g., real-time transaction report) detailing the conversion of recognition units into statement credits or other forms of rewards. For example, the report can made accessible through the GUI, providing the user with a summary or detailed overview of conversion/allocation actions. For example, the report can show a breakdown of how different types of merchant points are converted into credits, along with the conversion rates and resulting balances. Further, the provider exchange system 110 can generate a summary of the user's historical recognition unit transactions and conversions, which can identify patterns and trends in the user's redemption behavior. The historical analysis can be used by the provider exchange system 110 to offer recommendations for future conversions or redemptions through the GUI. For example, if the system observes that the user frequently converts travel rewards into financial credits during specific periods, the provider exchange system 110 can provide content or other data to suggest similar actions in response to detecting a repeat occurrence of favorable redemption conditions. Additionally, the method can include determining a timing (e.g., optimal timing) for converting recognition units by assessing fluctuating exchange rates and past redemption history of the user. In some arrangement, the provider exchange system 110 can alert the user of certain times or dates (e.g., the best time or date) to convert earned, allocated, and/or unallocated units into credits or other valuable forms (e.g., to maximize user benefits). For example, the provider exchange system 110 can notify the user when the conversion rate for transferring dining points into financial institution rewards is particularly high, advising the user to convert at that moment for the best value.

In some arrangements, the state change of the recognition units can include dynamically adjusting the conversion rates offered by the provider based on various criteria or factors (e.g., based on updated merchant-provider exchange parameters, competitive analyses, market conditions, etc.). For example, the provider exchange system 110 can update the user's statement credit balance to reflect adjustments made using the provider's mobile application. For example, if market trends indicate a higher value for converting retail points into financial institution credits, the provider exchange system 110 can automatically adjust the conversion rates and apply these new rates to the user's account (e.g., a merchant account with at least one linked merchant, a provider account with the provider, etc.). Additionally, the method can include identifying by the provider exchange system 110, the balance and expiration dates of the recognition units across a plurality of linked merchants through the provider's mobile application. The provider exchange system 110 can recommend or provide a recommendation message (e.g., via content of an actionable element or actionable item) for converting recognition units nearing expiration to prevent loss of rewards. For example, the system can alert a user when their travel rewards are close to expiring and suggest converting them into financial institution credits to maintain their value. The provider exchange system 110 can also verify that various conditions or aspects of a conversion between provider/merchant rewards are satisfied and provide the user with the various tools and insights regarding such rewards (e.g., allocation summary, notification of conversion opportunity, etc.). In summary, the various systems and methods described herein include a range of functionalities to facilitate users efficiently managing, converting, or allocating recognition units across different merchant partners and financial institution accounts. For example, the systems and methods described herein can include features for automatic and manual conversions, real-time tracking and synchronization of balances, detailed transaction reporting, and intelligent recommendations based on historical and market data.

Referring now to FIG. 3, block diagram illustrating an example computing system 300 suitable for use in the various arrangements described herein is shown. The computing system 300 can represent provider exchange system 110, database 120, user devices 140, third party computing systems 150, and/or various other example computing systems described herein. FIG. 3 is a block diagram illustrating an example computing system suitable for use in the various arrangements described herein, according to some arrangements. The computing system 300 includes a bus 305 or other communication component for communicating information and a processor 310 coupled to the bus 305 for processing information. The computing system 300 also includes main memory 315, such as a random-access memory (RAM) or other dynamic storage device, coupled to the bus 305 for storing information, and instructions to be executed by the processor 310. Main memory 315 can also be used for storing position information, temporary variables, or other intermediate information during execution of instructions by the processor 310. The computing system 300 can further include a read only memory (ROM) 320 or other static storage device coupled to the bus 305 for storing static information and instructions for the processor 310. A storage device 325, such as a solid-state device, magnetic disk, or optical disk, is coupled to the bus 305 for persistently storing information and instructions.

The computing system 300 can be coupled via the bus 305 to a display 335, such as a liquid crystal display, or active-matrix display, for displaying information to a user. An input device 330, such as a keyboard including alphanumeric and other keys, can be coupled to the bus 305 for communicating information, and command selections to the processor 310. In another arrangement, the input device 330 has a touch screen display 335. The input device 330 can include any type of input device, such as a biometric sensor, a cursor control, such as a mouse, a trackball, or cursor direction keys, for communicating direction information and command selections to the processor 310 and for controlling cursor movement on the display 335.

In some arrangements, the computing system 300 can include a communications adapter 340, such as a networking adapter. Communications adapter 340 can be coupled to bus 305 and can be configured to facilitate communications with a computing or communications network 130 and/or other computing systems. In various illustrative arrangements, any type of networking configuration can be achieved using communications adapter 330, such as wired (e.g., via Ethernet), wireless (e.g., via Wi-Fi, Bluetooth), satellite (e.g., via GPS) pre-configured, ad-hoc, LAN, WAN.

According to various arrangements, certain processes that effectuate illustrative arrangements that are described herein can be achieved by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement can also be employed to execute the instructions contained in main memory 315. In alternative arrangements, hard-wired circuitry can be used in place of or in combination with software instructions to implement illustrative arrangements. Thus, arrangements are not limited to any specific combination of hardware circuitry and software.

Although an example processing system has been described in FIG. 3, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 3 as singular, stand-alone devices, one of ordinary skill in the art will appreciate that, in some arrangements, the computing system 300 can include virtualized systems and/or system resources. For example, in some arrangements, the computing system 300 can be a virtual switch, virtual router, virtual host, virtual server. In various arrangements, computing system 300 can share physical storage, hardware, and other resources with other virtual machines. In some arrangements, virtual resources of the network 130 (e.g., network 130 of FIG. 1) can include cloud computing resources such that a virtual resource can rely on distributed processing across more than one physical processor, distributed memory, etc.

Referring now to FIGS. 4A-4B, example graphical user interfaces depicting an application user interface 400 are shown, according to some arrangements. In general, the application user interface 400 (or “graphical user interface 400,” “GUI 400,” etc.) facilitates synchronization and/or linking of exchanges or accounts between a user, a provider, and one or more merchants. In some arrangements, the graphical user interface 400 is provided by a user device (e.g., mobile device 140 of FIG. 1), via a client or user application provided and supported by a mobile computing device (i.e., as a downloaded application configured to execute or run on the client or user device). In other arrangements, the graphical user interface 400 is provided (e.g., by user device 140, provider exchange system 110 of FIG. 1) as a hosted website and is accessible by the user device via a network (e.g., network 130 of FIG. 1).

In some arrangements, the graphical user interface 400 can include a variety of content, such as one or more content items or content of interactive elements. For example, the content can include information such as a total balance, environmental information such as current date/time and/or device battery status, and other information related to exchanges, accounts, merchants, providers, recognition units, or various other data related to the user, a linked merchant, or a provider (e.g., provider logo, merchant account username, etc.). In some arrangements, the graphical user interface 400 facilitates the allocation or redemption of recognition units (e.g., rewards, credits, points, etc.) by a user with one or more linked merchants or a provider via the user interacting with actionable elements including content also referred to as “content items”). In some arrangements, the interactive elements (e.g., actionable element, input field, content item, etc.) can receive an input, via an electronic device 140, and be updated as the user inputs (or interacts) with the interactive or actionable element. In various arrangements, various pages (e.g., exchange pages, point redemption pages, etc.) can be displayed by graphical user interface 400 and can include an individual interface such as a first application user interface, a second application interface, a third application interface, and so on. In some arrangements, the user can interact with the various content items and/or actionable elements to perform various functions and/or to access or view various pages (e.g., transactions page, redemption page, etc.) displayed by the GUI 400.

Referring now to FIG. 4A, the graphical user interface 400 can include content items and/or actionable elements corresponding to a list of transactions or exchanges (e.g., all transactions/exchanges between a user and one or more linked merchants facilitated by a provider) displayed on the user device 140. For example, as shown on FIG. 4A, the graphical user interface 400 can include a list of transactions/exchanges (e.g., exchange history data 406), which can include a log of past and/or pending exchanges between the user and various merchants or a provider, and which can be presented via the mobile electronic device 140 to the user for viewing. In one particular example, the GUI 400 may correspond to a mobile banking application, and the list of transactions/exchanges may be a list of purchases or payments corresponding to transaction card activity (e.g., credit card activity). The GUI 400 may also include various actionable items or user inputs for providing user information, such as a redeem rewards element 402. In some arrangements, as shown in FIG. 4A, the GUI 400 can include one or more exchanges 408a-408n (collectively, exchanges 408) and states 410a-410n (collectively, states 410). For example, the exchange 408a can include a merchant name (e.g., “Fargo Eatery”), a state 410a (e.g., “Linked,” “Unlinked,” “Allocated,” “Unallocated,” “Merchant Redemption,” “Provider Redemption,” etc.), exchange amount (e.g., transaction balance, total cost, currency spent, etc.), and/or various additional and/or alternative content fields and actionable elements. In another example, the exchange 408b and the exchange 408n can include similar or additional information as described regarding the exchange 408a, but corresponding to each of the exchanges 408b-408n in the exchange history data 406 (e.g., information on additional linked or partnered merchants (e.g., Wells Theatres, WF Gym+Spa, etc.), exchange totals such as $20.31, a state 401b of “linked,” a state 410n of “unlinked,” etc.). In some arrangements, the states 410 include data entries or stored data corresponding to recognition units associated with the exchanges 408 being allocated to a merchant or to a provider, which can be updated or otherwise modified in response to various condition and/or user input (e.g., a selection via the GUI 400). In other arrangements, the states 410 can include various additional or alternative states, conditions, or statuses corresponding to the exchanges 408 or to recognition units created or generated based on one or more of the exchanges 408, such as a “spent” allocation state (e.g., corresponding to recognition units already allocated, redeemed, and/or spent by the user) and/or an “ineligible” allocation state (e.g., corresponding to an exchange not eligible for earning recognition units). The GUI 400 can also include balance data 404 (e.g., a statement balance or total, such as a negative balance of “−$55.20” or another total). For example, the balance data 404 (e.g., provider account summary, user statement balance, etc.) can be updated based on the conversion/allocation of the recognition units (e.g., 60 points converted to 90 points and credited to a user or provider balance), and the updated balance data 404 can be displayed (e.g., via a provider GUI in a viewport of a provider mobile application). In an example, in response to the user interacting with (e.g., clicking, selecting, pressing, etc.) one or more of the states 410 or the corresponding exchange 408 (e.g., a state 410b of the exchange 408b, a state 410n of the exchange 408n, etc.), the GUI 400 can display a detailed transaction page with information and/or various user inputs related to a specific transaction selected. In another example, in response to the user selecting or providing a selection of the redeem rewards element 402, the GUI 400 can display the detailed transaction page (e.g., configured to provide information and/or accept user input corresponding to specific transaction/exchange).

Still referring to FIG. 4A, the graphical user interface 400 can include content items and/or actionable elements corresponding to one or more of the exchanges 408 (e.g., content items and/or actionable elements for viewing exchange parameters, other exchange data, or recognition unit data corresponding to a specific transaction included in the list of all transactions) displayed on the user device 140. For example, as shown in FIG. 4A, the GUI 400 can include data corresponding the exchange 408a, such as an transaction/exchange identifier or ID (e.g., “Transaction #53214”), an exchange reward or recognition unit item (e.g., “You've earned 60 points”), and transaction/exchange details (e.g., exchange amount of “$60.02,” exchange date of May 1, 2023, etc.), and more. In some arrangements, the GUI 400 can further include various additional and/or alternative content items or user input features, such as a linked merchant element 412 (e.g., for viewing a list of linked merchants eligible for agnostic redemption in response to selecting the merchant element 412) and/or a redemption element 416 (e.g., “Redeem Points” button). Further, the GUI 400 can include a state 418 (e.g., content item, actionable element, etc.) and/or various state information related to the exchange 408a. For example, the state 418 can include state information, such as content or actionable elements indicating allocation status (e.g., a first state such as a merchant redemption state, a second state such as a provider redemption state, etc.) or other information related to recognition units earned through the exchange 408a. As shown in FIG. 4A, for example, the state 418 corresponds to a merchant recognition state. For example, various recognition states (e.g., merchant state, provider states, etc.) can include the recognition units being assignable for spending with a merchant and/or with a provider. In an example, in response to the user interacting with (e.g., clicking, selecting, pressing, etc.) the redemption element 416, the GUI 400 can display an additional page with information for allocating at least one recognition unit (e.g., 60 points) earned through the exchange 408a.

Referring now to FIG. 4B, the graphical user interface 400 can include content items and/or actionable elements corresponding to a redemption interface (e.g., or allocating earned recognition units with one entity to another linked entity) displayed on the user device 140. For example, as shown on FIG. 4A, the graphical user interface 400 can a page or interface title (e.g., “Redeem Points”), user guidance or instructional elements and/or information (e.g., “Select a Provider or a Merchant for Redemption”), a recognition unit quantity (e.g., 60 points), and more. In some arrangements, the GUI 400 can include a merchant redemption element 420 and a provider redemption element 422. In some examples, depending on the first state or on a portion of the first state of the one or more recognition units, a selection of one of the merchant redemption element 420 or the provider redemption element 422 can be displayed (e.g., via a an electronic display of the user device 140). For example, in response to determining the state 418 of the recognition units earned through the exchange 408a being a “merchant redemption state,” the GUI 400 can display the provider redemption element 422 (e.g., in a typical layout common to other elements of the GUI, in a manner to cause selection, such as being highlighted) to direct the user to select an assignable or appropriate allocation (e.g., to convert or update the merchant redemption state into a provider redemption state). In an example, in response to the user interacting with (e.g., clicking, selecting, pressing, etc.) one or more of the merchant redemption element 420 or the provider redemption element 422, the GUI 400 can display a selection page (e.g., rewards allocation page with exchange parameters and/or conversion rates for allocation).

Referring now to FIG. 4B, the graphical user interface 400 can include content items and/or actionable elements corresponding to a redemption interface or a selection interface (e.g., or allocating earned recognition units with one entity to another linked entity according to a selected conversion rate) displayed on the user device 140. In an example, the interface presented by the graphical user interface 400 can include an updated redemption interface including one or more content items and/or actionable elements as described regarding FIG. 4A. In another example, the GUI can display or provide a selection interface with various content items and/or actionable elements for selecting at least one state change option (e.g., for allocating merchant/provider credits). For example, as shown in FIG. 4B, the GUI 400 can include a first exchange rate element 424a (or rate 424a) and a second exchange rate element 424b (collective, exchange rate elements 424). The GUI 400 can further include an indication element 426. In some arrangements, the GUI 400 can also include a first provider-merchant exchange parameter element 428a and a second provider-merchant exchange parameter element 428b (collectively, merchant-provider exchange parameters 428). For example, the first merchant-provider exchange parameter element 428a can include allocation information corresponding to an allocation made in response to a user selection of the first exchange rate element 424a. In another example, the second provider-merchant exchange parameter element 428b can also include allocation information, the information corresponding to an allocation made in response to a user selection of the second merchant-provider exchange parameter element 428b. In some arrangements, the GUI 400 can include an indication element 426 to identify or provide a preferred conversion rate by adjusting, modifying, highlighting, outlining, or otherwise indicating one of the first exchange rate element 424a or the second exchange rate element 424b for a user selection (e.g., based on modeling data of the first provider-merchant exchange parameter element 428a and data of the second provider-merchant exchange parameter element 428b to determine predicted or expected allocation amounts). For example, the first provider-merchant exchange parameter element 428a can correspond to the first exchange rate element 424a and be indicated by the indication element 426 in response to identification as a preferred exchange rate/parameter (e.g., providing a conversion rate of 1:1.5 points for allocating 60 merchant-redeemable points to be redeemed as 90 provider-redeemable points). In another example, the first provider-merchant exchange parameter element 428a and second provider-merchant exchange parameter element 428b can include allocation totals based on modeling exchange rates/parameters (e.g., an allocation value of $90 based on calculating an equivalent recognition unit value of 90 points based on an exchange rate of 1:1.5, as shown in FIG. 4B). Further, in response to the user interacting with (e.g., first exchange rate element 424a, second exchange rate element 424b clicking, selecting, pressing, etc.) one or more of the first exchange rate element 424a or the second exchange rate element 424b, the GUI 400 can execute or perform various functions, including facilitating the conversion or allocation of the recognition units according to a selected exchange rate element (e.g., one or more of the first exchange rate element 424a or the second exchange rate element 424b). In some arrangements, the GUI 400 can display an allocation summary page with information and/or various user inputs related an allocation according to the selected first exchange rate element 424a or the selected second exchange rate element 424b (e.g., depending on which of the exchange rate elements 424 are selected by the user) in response to user input.

Still referring to FIG. 4B, the graphical user interface 400 can include content items and/or actionable elements corresponding to one or more of the exchanges 408 (e.g., content items and/or actionable elements for viewing exchange parameters, other exchange data, or recognition unit data corresponding to a specific transaction included in the list of all transactions) displayed on the user device 140. For example, as shown in FIG. 4B, the GUI 400 can include the state 418 and an allocation summary 430. In one example, the state 418 can be updated by the GUI 400 (e.g., in response to an update from a provider redemption state to a merchant redemption state, corresponding to an allocation from a user account with a provider to a user account with a merchant). For example, the state 418 can be updated to the “Provider Redemption State” such that the recognition unit(s) (e.g., 90 points) are redeemable with the provider (e.g., with a provider account of the user with the provider) after being in a merchant redemption state redeemable with a linked merchant (e.g., with a merchant account of the user with the linked merchant). In another example, the allocation summary 430 can include data from modeling or from calculating an allocation total (e.g., recognition unit amount, converted rewards total, etc.), such as “You've Added 90 Points to Your Statement Balance” in response to allocating the 90 points/recognition units to the provider account of the user. In some arrangements, the GUI 400 can further include various content items or actionable items/elements with content corresponding to an exchange (e.g., an exchange initiating or causing the generation or identification of recognition units). For example, the GUI 400 can include a transaction identifier or exchange ID, merchant name, linked merchants element, user input devices for navigating home/accounts/settings pages, and/or linking data (e.g., corresponding to a “linked”state).

Still referring to FIG. 4B, the graphical user interface 400 can include content items and/or actionable elements corresponding to a list of transactions or exchanges (e.g., as shown on FIG. 4A or including similar elements) displayed on the user device 140. For example, as shown on FIG. 4B, the graphical user interface 400 can include the exchange history data 406, which can include a log of past and/or pending exchanges between the user and various merchant, and the one or more exchanges 408a-408n and states 410a-410n. In an example, in response to an allocation or conversion of merchant recognition units, provider recognition units, and/or states of recognition units of various types, the GUI 400 can update the included content and actionable elements to indicate the allocation/conversion (e.g., the balance data 404). For example, the balance data 404 (e.g., provider account summary, user statement balance, etc.) can be updated based on the conversion/allocation of the recognition units (e.g., 60 points converted to 90 points and credited to a user or provider balance), and the updated balance data 404 can be displayed (e.g., via a provider GUI in a viewport of a provider mobile application). For example, balance data 404 corresponding to a negative balance of “−$55.20” can be updated to a positive balance of “+$34.80” in response to an allocation of 90 recognition units (e.g., redeemable at a 1:1 point or recognition unit to dollar conversion rate).

The embodiments described herein have been described with reference to drawings. The drawings illustrate certain details of specific embodiments that implement the systems, methods and programs described herein. However, describing the embodiments with drawings should not be construed as imposing on the disclosure any limitations that can be present in the drawings.

It should be understood that no claim element herein is to be construed under the provisions of 35 U.S.C. §112(f), unless the element is expressly recited using the phrase “means for.”

As used herein, the term “circuit” can include hardware structured to execute the functions described herein. In some embodiments, each respective “circuit” can include machine-readable media for configuring the hardware to execute the functions described herein. The circuit can be embodied as one or more circuitry components including, but not limited to, processing circuitry, network interfaces, peripheral devices, input devices, output devices, sensors, etc. In some embodiments, a circuit can take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” can include any type of component for accomplishing or facilitating achievement of the operations described herein. For example, a circuit as described herein can include one or more transistors, logic gates (e.g., NAND, AND, NOR, OR, XOR, NOT, XNOR), resistors, multiplexers, registers, capacitors, inductors, diodes, wiring, and so on.

The “circuit” can also include one or more processors communicatively coupled to one or more memory or memory devices. In this regard, the one or more processors can execute instructions stored in the memory or can execute instructions otherwise accessible to the one or more processors. In some embodiments, the one or more processors can be embodied in various ways. The one or more processors can be constructed in a manner sufficient to perform at least the operations described herein. In some embodiments, the one or more processors can be shared by multiple circuits (e.g., circuit A and circuit B can comprise or otherwise share the same processor which, in some example embodiments, can execute instructions stored, or otherwise accessed, via different areas of memory). Alternatively or additionally, the one or more processors can be structured to perform or otherwise execute certain operations independent of one or more co-processors. In other example embodiments, two or more processors can be coupled via a bus for independent, parallel, pipelined, or multi-threaded instruction execution. Each processor can be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors can take the form of a single core processor, multi-core processor (e.g., a dual core processor, triple core processor, quad core processor), microprocessor, etc. In some embodiments, the one or more processors can be external to the apparatus, for example the one or more processors can be a remote processor (e.g., a cloud based processor). Alternatively or additionally, the one or more processors can be internal and/or local to the apparatus. In this regard, a given circuit or components thereof can be disposed locally (e.g., as part of a local server, a local computing system) or remotely (e.g., as part of a remote server such as a cloud based server). To that end, a “circuit” as described herein can include components that are distributed across one or more locations.

An exemplary system for implementing the overall system or portions of the embodiments can include a general purpose computing devices in the form of computers, including a processing unit, a system memory, and a system bus that couples various system components including the system memory to the processing unit. Each memory device can include non-transient volatile storage media, non-volatile storage media, non-transitory storage media (e.g., one or more volatile and/or non-volatile memories), etc. In some embodiments, the non-volatile media can take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media can take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device can be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, can include any type of input device including, but not limited to, a keyboard, a keypad, a mouse, joystick or other input devices performing a similar function. Comparatively, the term “output device,” as described herein, can include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein can show a specific order and composition of method steps, it is understood that the order of these steps can differ from what is depicted. For example, two or more steps can be performed concurrently or with partial concurrence. Also, some method steps that are performed as discrete steps can be combined, steps being performed as a combined step can be separated into discrete steps, the sequence of certain processes can be reversed or otherwise varied, and the nature or number of discrete processes can be altered or varied. The order or sequence of any element or apparatus can be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure can be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or can be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions can be made in the design, operating conditions and embodiment of the embodiments without departing from the scope of the present disclosure as expressed in the appended claims.

What is claimed is:

1. A method for synchronizing user data of a user, the method comprising:
identifying, by one or more processing circuits, a plurality of recognition units of the user, wherein at least one recognition unit of the plurality of recognition units corresponds to a first state of a plurality of states, and wherein the at least one recognition unit corresponds to at least one linked merchant of a plurality of linked merchants;
generating, by the one or more processing circuits, one or more actionable elements comprising content corresponding to the at least one recognition unit, wherein at least one of the one or more actionable elements corresponds with a state change from the first state of the plurality of states to a second state of the plurality of states based on a merchant-provider exchange parameter;
providing, by the one or more processing circuits to a mobile device of the user, the one or more actionable elements to a graphical user interface (GUI) of a provider mobile application;
receiving, by the one or more processing circuits and via the GUI, a selection of the one or more actionable elements corresponding with a request to update a portion of the first state of the at least one recognition unit to the second state based on the merchant-provider exchange parameter;
updating, by the one or more processing circuits, the portion of the first state of the at least one recognition unit to the second state, wherein updating comprises:
deducting, by the one or more processing circuits, the at least one recognition unit from a first account of the user;
calculating, by the one or more processing circuits, an equivalent recognition unit value based on the merchant-provider exchange parameter;
updating, by the one or more processing circuits, a recognition unit value of the at least one recognition unit based on the equivalent recognition unit value; and
allocating, by the one or more processing circuits, the at least one recognition unit to a second account of the user based on the equivalent recognition unit value and the second state of the plurality of states.

2. The method of claim 1, further comprising:
establishing, by the one or more processing circuits, a data communications link with a merchant computing system of the at least one linked merchant;
modifying, by the one or more processing circuits and via the data communications link, stored data corresponding to the plurality of recognition units based on updating the first state of the plurality of states into the second state of the plurality of states;
updating, by the one or more processing circuits, the content of the one or more actionable elements corresponding with a successful conversion of the first state to the second state; and
providing, by the one or more processing circuits, the updated content of the one or more actionable elements to the GUI of the provider mobile application.

3. The method of claim 1, further comprising:
receiving, by the one or more processing circuits, exchange data for an exchange between the user and the at least one linked merchant facilitated by the provider, the exchange data comprising the merchant-provider exchange parameter; and
identifying, by the one or more processing circuits and in response to receiving the exchange data, at least one first state change option of a plurality of state change options, the at least one first state change option corresponding to the state change from the first state of the plurality of states to the second state of the plurality of states.

4. The method of claim 3, wherein identifying the at least one first state change option further comprises:
determining, by the one or more processing circuits, at least one second state change option of the plurality of state change options, the at least one second state change option comprising at least one second merchant-provider exchange parameter;
modeling, by the one or more processing circuits, a first exchange rate based on the merchant-provider exchange parameter and a second exchange rate based on the second merchant-provider exchange parameter; and
determining, by the one or more processing circuits, a preferred exchange rate based on the modeled first exchange rate and the modeled second exchange rate.

5. The method of claim 4, further comprising:
generating, by the one or more processing circuits, at least one indication element comprising content indicating the preferred exchange rate;
updating, by the one or more processing circuits, the content of the one or more actionable elements to comprise the at least one indication element, wherein updating comprises grouping the at least one indication element with the preferred exchange rate; and
providing, by the one or more processing circuits, the updated content of the one or more actionable elements comprising the at least one indication element to the GUI in a viewport of the provider mobile application.

6. The method of claim 1, further comprising:
generating, by the one or more processing circuit and in response to identifying at least one state change option, a first recognition unit of a first type based on the at least one recognition unit and the merchant-provider exchange parameter, wherein the first type is a merchant recognition unit type assignable for exchanges between the user and the at least one merchant of the plurality of linked merchants;
linking, by the one or more processing circuits, the first recognition unit of the first type with the first account of the user, wherein the first account of the user corresponds to the at least one linked merchant of the plurality of linked merchants;
generating, by the one or more processing circuits, a second recognition unit of a second type based on the at least one state change option and the merchant-provider exchange parameter, wherein the second type is a provider recognition unit type assignable for one or more provider exchanges between the user and the provider; and
linking, by the one or more processing circuits, the second recognition unit of the second type with the second account of the user, wherein the second account of the user corresponds to the provider.

7. The method of claim 6, wherein allocating further comprises:
linking, by the one or more processing circuits, the first recognition unit of the first type with the first account of the user based on the merchant-provider exchange parameter, wherein the first account of the user corresponds to the at least one linked merchant of the plurality of linked merchants; and
generating, by the one or more processing circuits, a second recognition unit of a second type based on the at least one recognition unit and the merchant-provider exchange parameter, wherein the second type is a provider recognition unit type.

8. The method of claim 1, wherein the first state is a merchant redemption state, wherein the second state is a provider redemption state, wherein the first account is a merchant account of the user with the at least one linked merchant, and wherein the second account is a provider account of the user with the provider.

9. The method of claim 1, wherein the first state is a provider redemption state, wherein the second state is a merchant redemption state, wherein the first account is a provider account of the user with the provider, and wherein the second account is a merchant account of the user with the at least one linked merchant.

10. A system for synchronizing user data of a user, the system comprising:
one or more processing circuits configured to:
identify a plurality of recognition units of the user, wherein at least one recognition unit of the plurality of recognition units corresponds to a first state of a plurality of states, and wherein the at least one recognition unit corresponds to at least one linked merchant of a plurality of linked merchants;
generate one or more actionable elements comprising content corresponding to the at least one recognition unit, wherein at least one of the one or more actionable elements corresponds with a state change from the first state of the plurality of states to a second state of the plurality of states based on a merchant-provider exchange parameter;
provide, to a mobile device of the user, the one or more actionable elements to a graphical user interface (GUI) of a provider mobile application;
receive, via the GUI, a selection of the one or more actionable elements corresponding with a request to update a portion of the first state of the at least one recognition unit to the second state based on the merchant-provider exchange parameter;
update the portion of the first state of the at least one recognition unit to the second state, wherein updating comprises:
deduct the at least one recognition unit from a first account of the user;
calculate an equivalent recognition unit value based on the merchant-provider exchange parameter;
update a recognition unit value of the at least one recognition unit based on the equivalent recognition unit value; and
allocate the at least one recognition unit to a second account of the user based on the equivalent recognition unit value and the second state of the plurality of states.

11. The system of claim 10, wherein the one or more processing circuits are further configured to:
establish a data communications link with a merchant computing system of the at least one linked merchant;
modify, via the data communications link, stored data corresponding to the plurality of recognition units based on updating the first state of the plurality of states into the second state of the plurality of states;
update the content of the one or more actionable elements corresponding with a successful conversion of the first state to the second state; and
provide the updated content of the one or more actionable elements to the GUI of the provider mobile application.

12. The system of claim 10, wherein the one or more processing circuits are further configured to:
receive exchange data for an exchange between the user and the at least one linked merchant facilitated by the provider, the exchange data comprising the merchant-provider exchange parameter; and
identify, in response to receiving the exchange data, at least one first state change option of a plurality of state change options, the at least one first state change option corresponding to the state change from the first state of the plurality of states to the second state of the plurality of states.

13. The system of claim 12, wherein the one or more processing circuits are further configured, in identifying the at least one first state change option, to:
determine at least one second state change option of the plurality of state change options, the at least one second state change option comprising at least one second merchant-provider exchange parameter;
model a first exchange rate based on the merchant-provider exchange parameter and a second exchange rate based on the second merchant-provider exchange parameter; and
determine a preferred exchange rate based on comparing the modeled first exchange rate to the modeled second exchange rate.

14. The system of claim 13, wherein the one or more processing circuits are further configured to:
generate at least one indication element comprising content indicating the preferred exchange rate;
update the content of the one or more actionable elements to comprise the at least one indication element, wherein updating comprises grouping the at least one indication element with the preferred exchange rate; and
provide the updated content of the one or more actionable elements comprising the at least one indication element to the GUI in a viewport of the provider mobile application.

15. The system of claim 10, wherein the one or more processing circuits are further configured to:
generate, in response to identifying at least one state change option, a first recognition unit of a first type based on the at least one recognition unit and the merchant-provider exchange parameter, wherein the first type is a merchant recognition unit type assignable for exchanges between the user and the at least one merchant of the plurality of linked merchants;
link the first recognition unit of the first type with the first account of the user, wherein the first account of the user corresponds to the at least one linked merchant of the plurality of linked merchants;
generate a second recognition unit of a second type based on the at least one state change option and the merchant-provider exchange parameter, wherein the second type is a provider recognition unit type assignable for one or more provider exchanges between the user and the provider; and
link the second recognition unit of the second type with the second account of the user, wherein the second account of the user corresponds to the provider.

16. The system of claim 10, wherein the first state is a merchant redemption state, wherein the second state is a provider redemption state, wherein the first account is a merchant account of the user with the at least one linked merchant, and wherein the second account is a provider account of the user with the provider.

17. The system of claim 10, wherein the first state is a provider redemption state, wherein the second state is a merchant redemption state, wherein the first account is a provider account of the user with the provider, and wherein the second account is a merchant account of the user with the at least one linked merchant.

18. One or more non-transitory computer-readable media (CRM) having instructions stored thereon that, when executed by one or more processing circuits, cause the one or more processing circuits to:
identify a plurality of recognition units of a user, wherein at least one recognition unit of the plurality of recognition units corresponds to a first state of a plurality of states, and wherein the at least one recognition unit corresponds to at least one linked merchant of a plurality of linked merchants;
generate one or more actionable elements comprising content corresponding to the at least one recognition unit, wherein at least one of the one or more actionable elements corresponds with a state change from the first state of the plurality of states to a second state of the plurality of states based on a merchant-provider exchange parameter;
provide, to a mobile device of the user, the one or more actionable elements to a graphical user interface (GUI) of a provider mobile application;
receive, via the GUI, a selection of the one or more actionable elements corresponding with a request to update a portion of the first state of the at least one recognition unit to the second state based on the merchant-provider exchange parameter;
update the portion of the first state of the at least one recognition unit to the second state, wherein updating comprises:
deduct the at least one recognition unit from a first account of the user;
calculate an equivalent recognition unit value based on the merchant-provider exchange parameter;
update a recognition unit value of the at least one recognition unit based on the equivalent recognition unit value; and
allocate the at least one recognition unit to a second account of the user based on the equivalent recognition unit value and the second state of the plurality of states.

19. The one or more non-transitory CRM of claim 18, wherein the first state is a merchant redemption state, wherein the second state is a provider redemption state, wherein the first account is a merchant account of the user with the at least one linked merchant, and wherein the second account is a provider account of the user with the provider.

20. The one or more non-transitory CRM of claim 18, wherein the first state is a provider redemption state, wherein the second state is a merchant redemption state, wherein the first account is a provider account of the user with the provider, and wherein the second account is a merchant account of the user with the at least one linked merchant.
